(19) United States
(12) Patent Application Publication
(10) Pub. No.: US 2026/0095988 A1
(43) Pub. Date: Apr. 2, 2026

(54) PULSED LIGHT-EMITTING DIODE DRIVER WITH HIGH-SPEED VOLTAGE DETECTION MODULE

(71) Applicant: Silanna Asia Pte Ltd, Singapore (SG)

(72) Inventors: Russell Hayter, Sydney (AU); William E. Rader, III, Carrboro, NC (US); Kenneth Leigh Boyden, Wake Forest, NC (US); Stuart B. Molin, Carlsbad, CA (US); Steven E. Rosenbaum, San Diego, CA (US)

(73) Assignee: Silanna Asia Pte Ltd, Singapore (SG)

(21) Appl. No.: 19/339,662

(22) Filed: Sep. 25, 2025

Related U.S. Application Data
(60) Provisional application No. 63/699,965, filed on Sep. 27, 2024.

(51) Int. Cl. H05B 45/3725; G01S 7/481; G01S 7/484; H05B 45/34; H05B 45/345

(52) U.S. Cl. CPC H05B 45/3725; G01S 7/4814; G01S 7/484; H05B 45/34; H05B 45/345

(57) ABSTRACT

An apparatus includes a voltage detection module and a sense resistor configured to couple a low-voltage domain of the voltage detection module to a high-voltage node of an external circuit and to develop a sense current based on a voltage developed at the high-voltage node, the sense current being received at a sensing node of the voltage detection module. The voltage detection module includes a reference network configured to establish one or more threshold conditions at respective internal nodes within the voltage detection module, the one or more threshold conditions being generated based on one or more biasing circuits, and a comparison network configured to generate one or more comparison output signals based on a received current level of the sense current and the one or more threshold conditions.

### RELATED APPLICATIONS

This Non-Provisional Patent application claims priority to U.S. Provisional Patent Application No. 63/699,965, filed Sep. 27, 2024, all of which is incorporated by reference herein in its entirety.

### BACKGROUND

Pulsed light-emitting diodes are used in various applications, such as laser-based ranging systems (e.g., LiDAR), optical communication systems, spectroscopy applications, stroboscopic applications, and biometric devices. Such applications often use a pulsed light-emitting diode driver circuit to generate a short, high-current pulse, which is passed through a light-emitting diode (LED) to emit a corresponding pulse of light.

However, parasitic inductances of the pulsed light-emitting diode driver circuit and the light-emitting diode itself typically must be overcome to achieve a desired short pulse width. For example, in the case of laser diode applications, many laser diodes have at least one bond wire which can contribute 1 nH of inductance, thereby limiting a slew rate of the current pulse unless there is very high voltage.

In pulsed light-emitting diode driver applications, accurate measurement of voltages at high-speed and across wide voltage ranges is often required to ensure reliable operation and protection of circuit components. The voltage present at various nodes within a driver circuit can fluctuate rapidly during pulse emission events, and may span both positive and negative domains well beyond typical logic levels. These conditions are especially prevalent in systems designed for applications such as LiDAR, optical communication, and spectroscopy, where precise control and monitoring of pulse characteristics are critical to system performance.

Conventional voltage measurement techniques in such environments face several challenges. For example, voltage domains may be separated from low-voltage control circuitry, necessitating the use of specialized sensing arrangements to bridge these domains without introducing excessive leakage currents or compromising measurement accuracy. Additionally, the presence of parasitic capacitances and inductances, as well as the need to sense voltages during rapid transients, can complicate the design of measurement modules.

### SUMMARY

In some aspects, the techniques described herein relate to an apparatus including: a voltage detection module; and a sense resistor configured to couple a low-voltage domain of the voltage detection module to a high-voltage node of an external circuit and to develop a sense current based on a voltage developed at the high-voltage node, the sense current being received at a sensing node of the voltage detection module; wherein the voltage detection module includes: a reference network configured to establish one or more threshold conditions at respective internal nodes within the voltage detection module, the one or more threshold conditions being generated based on one or more biasing circuits; and a comparison network configured to generate one or more comparison output signals based on a received current level of the sense current and the one or more threshold conditions.

### BRIEF DESCRIPTION OF THE DRAWINGS

FIG. 1 is a simplified circuit schematic of a pulsed light-emitting diode driver with a high-speed voltage detection module, in accordance with some examples.

FIG. 2 is a first example implementation of the high-speed voltage detection module introduced in FIG. 1.

FIG. 3 illustrates a second example implementation of the high-speed voltage detection module introduced in FIG. 1.

FIG. 4 illustrates details of the high-speed voltage detection module shown in FIG. 3, in accordance with some examples.

FIG. 5 illustrates a third example implementation of the high-speed voltage detection module introduced in FIG. 1.

FIGS. 6A-6B illustrate fourth and fifth example implementations of the high-speed voltage detection module introduced in FIG. 1.

FIGS. 7A-7B illustrate electrostatic discharge (ESD) protection circuits optionally used in the high-speed voltage detection module introduced in FIG. 1, in accordance with some examples.

FIG. 8 is a simplified circuit schematic of a variation on the pulsed light-emitting diode driver with a high-speed voltage detection module introduced in FIG. 1, in accordance with some examples.

FIGS. 9A-9B illustrate waveforms related to the operation of the pulsed light-emitting diode driver shown in FIG. 8, in accordance with some examples.

FIG. 10 is a simplified circuit schematic of a variation on the pulsed light-emitting diode driver with a high-speed voltage detection module introduced in FIG. 1, in accordance with some examples.

FIG. 11 illustrates waveforms related to the operation of the pulsed light-emitting diode driver shown in FIG. 10, in accordance with some examples.

FIG. 12 is a simplified circuit schematic of a variation on the pulsed light-emitting diode driver with a high-speed voltage detection module shown in FIG. 10, in accordance with some examples.

FIG. 13 illustrates waveforms related to the operation of the pulsed light-emitting diode driver shown in FIG. 12, in accordance with some examples.

FIG. 14 is a simplified circuit schematic of a variation on the pulsed light-emitting diode driver with a high-speed voltage detection module shown in FIG. 12, in accordance with some examples.

FIG. 15 illustrates waveforms related to the operation of the pulsed light-emitting diode driver shown in FIG. 14, in accordance with some examples.

FIG. 16 is a simplified circuit schematic of a variation of the pulsed light-emitting diode driver with a high-speed voltage detection module introduced in FIG. 1, in accordance with some examples.

FIG. 17 illustrates a sixth example implementation of the high-speed voltage detection module introduced in FIG. 1, in accordance with some examples.

FIG. 18 illustrates a seventh example implementation of the high-speed voltage detection module introduced in FIG. 1, in accordance with some examples.

### DETAILED DESCRIPTION

Many applications for laser diodes and light-emitting diodes (LEDs) require a single burst of very high current (for example 150A) for a short amount of time (for example 3 ns) followed by a much longer time (for example >1 us) before the next high current pulse. In order to achieve this extremely fast pulse, a voltage much higher than the forward voltage across the laser diode or LED is often presented from an anode to a cathode of the laser or LED to provide a rapid current increase across circuit board and component parasitic inductance. To subsequently rapidly decrease the current in the laser or LED, a significant negative voltage is often presented from the anode to the cathode of the laser or LED.

High-voltage domains in laser or LED driver (“driver”) applications often contain a low value of capacitance (for example, 1 nF). As such, any series resistance that is used for sensing voltage and/or current at a low-voltage domain of the driver (e.g., within a control module) should have a high value (for example, 10 MΩ) so that the sensed voltage node is not discharged. In this context, a high-voltage domain is a collection of electrical connections having one or more nodes that are at a voltage level greater than typical CMOS or TTL voltage levels, for example, greater than about 5V and often extending to tens or hundreds of volts, and may also reach large negative values, including tens to hundreds of volts below ground. Similarly, in this context, a low-voltage domain is a collection of electrical circuits in which all of the nodes are at or about typical CMOS or TTL voltage levels, for example, between 0V and 5V.

The use of a high value of external resistance, such as 10 MΩ, to “bridge” the high-voltage domain to the low-voltage domain requires that (1) the low-voltage sensing domain has an extremely low parasitic leakage current to any other nets (for example, <5 nA), and (2) an associated sensing circuit within the low-voltage sensing-domain must have high accuracy (for example, +/−10%) of the sensing element with low current levels into a sensing node (for example, 150 nA).

Wide input range, high-speed voltage detection circuits and methods for rapidly sensing the voltage on one or more of such nodes that can ring to a high positive voltage and a large negative voltage (for example, a range from −50V to 200V) with circuitry that is limited to a low positive-only voltage (for example, 0V to 5V) and has extremely low leakage current to other nets with high accuracy at low current levels are disclosed herein.

As but one example, the high-speed voltage detection circuits disclosed herein are configured for operation with pulsed light-emitting diode and/or laser diode drivers that create narrow (e.g., 1-5 nsec) high-current pulses (e.g., 40 A) through a driven light-emitting diode or laser diode using a resonant source capacitor that is rapidly refreshed after light pulse emission. Though both LED and laser diode applications are supported by the circuits and methods disclosed herein, the term “laser diode” is used hereinafter for brevity. However, it is understood that the term is taken to include non-laser light-emitting diodes in addition to laser diodes. Additionally, it is understood that the examples of high-speed voltage detection circuits disclosed herein may be used more generally in operational contexts other than LED and laser diode applications.

During operation of the pulsed laser diode driver, a source capacitor charge is refreshed using an inductor, a coupled inductor, or a transformer in a single switching cycle. In some examples, if the source capacitor needs to be charged to a voltage higher than the input voltage of the light-emitting diode driver circuit, a boost or a non-inverting buck-boost configuration is used to generate the source voltage.

In some examples, a current is developed through an inductor by connecting the inductor from an input voltage source to ground, from the input voltage source to the source capacitor, or a combination of the two. After a sufficient current is developed through the inductor (“fluxing”), the inductor is operable to provide all the needed charge to the source capacitor in one cycle by connecting the inductor from the input voltage source to the capacitor, or from ground to the capacitor, or by a combination of the two.

By providing all the needed charge for light pulse emission to the source capacitor in a single switching cycle, switching losses in a switched-mode power supply system providing the input voltage are advantageously minimized.

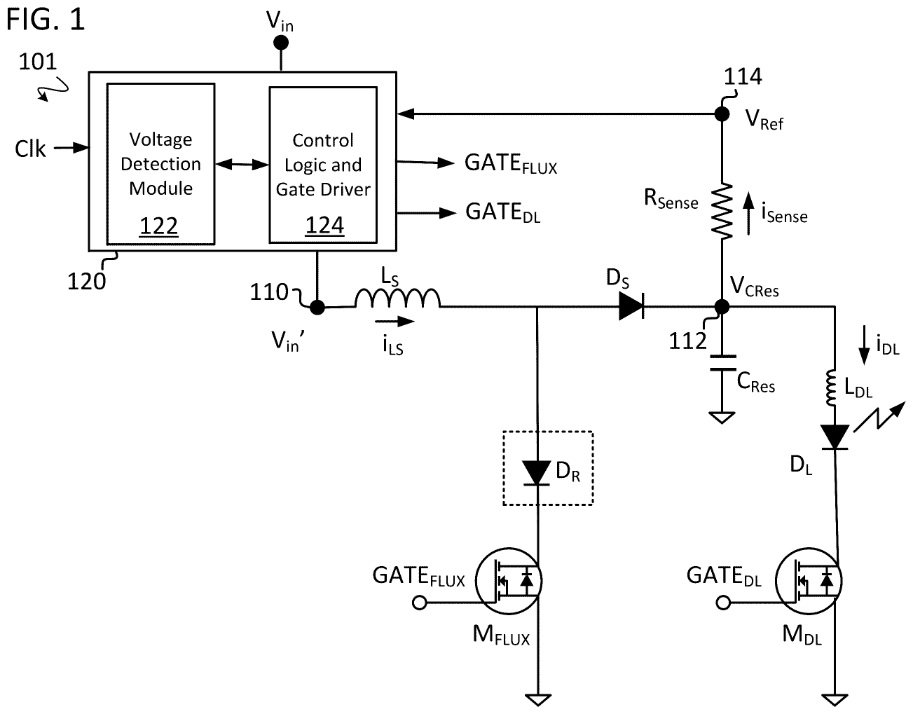

FIG. 1 is an operational environment for a wide input-range high-speed voltage detection circuit, shown in the context of a pulsed laser diode driver 101, in accordance with some examples. The laser diode driver 101 includes a control module 120, which may include, or may be in signal communication with, a high-speed voltage detection module 122 and a control logic and gate driver module 124. Though the voltage detection module 122 is shown and described with reference to detecting a voltage developed at the high-voltage node 112, it is understood that the voltage detection module 122, or additional instances of the voltage detection module 122 is/are operable to sense voltages at other nodes of the driver 101 or in other circuit contexts that may not be related to pulsed light emission applications. In the example shown, the voltage detection module 122, and circuitry therein, is of a low-voltage domain as introduced above, and the node 112 is of a high-voltage domain as introduced above. Any of the example implementations of the high-speed voltage detection module 122 disclosed herein are operable for use in the context of the driver 101.

In some scenarios, the control module 120 may also include an optional power converter (e.g., a switched-mode power supply, a buck converter, a boost converter, etc.) (not shown) to generate a regulated source voltage Vᵢₙ′ based on a received input voltage Vᵢₙ. In other scenarios, Vᵢₙ′ may be equal to Vᵢₙ. The example driver 101 also includes an inductor Ls (i.e., a physical component that is not representative of a parasitic inductance of another component), a voltage sense resistor R_{Sense}, a fluxing switch M_{FLUX}, a diode (which may be a standard diode or a Schottky diode) D_{S}, an optional reverse current protection diode D_{R}, a source capacitor C_{Res} (i.e., a physical component that is not representative of a parasitic capacitance of another component), a laser diode (or another light-emitting diode) D_{L}, and a pulse emission switch M_{DL}, connected as shown. In some examples, the diode D_{S} may be replaced by a different circuit element (not shown) that is operable to control a direction of current flow between the inductor Ls and the source capacitor C_{Res} (e.g., a PN diode, or an actively controlled switch). Though a laser diode D_{L} is shown and described in the simplified examples herein, it is understood that the element D_{L} may be a laser diode or other, more general, light-emitting diode.

Also shown is a master clock signal Clk, a current sense signal i_{Sense}, nodes 110, 112, 114, a parasitic inductance LDL of the laser diode D_{L}, an input voltage Vᵢₙ, a regulated input voltage Vᵢₙ′, a source voltage V_{CRes} at the source capacitor C_{Res}, a current i_{LS} through the inductor Ls, a current i_{DL} through the laser diode D_{L}, a fluxing switch gate driver signal GATE_{FLUX}, a regulated reference voltage V_{Ref}, and a pulse emission switch gate driver signal GATE_{DL}.

In some examples, the regulated input voltage Vᵢₙ′ is generated by the optional power converter (not shown) and is a higher or lower voltage level than the input voltage Vᵢₙ. In other examples, the regulated input voltage Vᵢₙ′ is the same voltage level as compared to the input voltage Vᵢₙ. For example, the regulated input voltage Vᵢₙ′ node 110 connected to the inductor Ls may be configured to receive 3V to 20V from a battery or other power source.

As shown, a first terminal of the inductor Ls is configured to receive an input voltage (either the input voltage Vᵢₙ or the regulated input voltage Vᵢₙ′). A second terminal of the inductor Ls is directly electrically connected to an anode of the diode D_{S} and is either directly electrically connected to a drain node of the fluxing switch M_{FLUX}, or electrically connected thereto through the diode D_{R}. A source node of the fluxing switch M_{FLUX} is directly electrically connected to ground. A cathode of the diode D_{S} is directly electrically connected to a first terminal of the source capacitor C_{Res} and to an anode of the laser diode D_{L}. A second terminal of the source capacitor C_{Res} is directly electrically connected to ground. A cathode of the laser diode D_{L} is directly electrically connected to a drain node of the pulse emission switch M_{DL}. A source node of the pulse emission switch M_{DL} is directly electrically connected to ground.

The controller 120 is operable to control a switching sequence for light pulse emissions based on the received master clock signal Clk and/or the current sense signal i_{Sense}. For example, the controller 120 is operable to generate the fluxing switch gate driver signal GATE_{FLUX} and the pulse emission switch gate driver signal GATE_{DL} based on the master clock signal Clk and a configurable pulse emission timing regime, and additionally in response to signals generated by the voltage detection module 122.

The fluxing switch M_{FLUX} is configured to receive the fluxing switch gate driver signal GATE_{FLUX} at a gate node, the fluxing switch gate driver signal GATE_{FLUX} being operable to turn the fluxing switch M_{FLUX} on or off based on a voltage level of the fluxing switch gate driver signal GATE_{FLUX}. Similarly, the pulse emission switch M_{DL} is configured to receive the pulse emission switch gate driver signal GATE_{DL} at a gate node, the pulse emission switch gate driver signal GATE_{DL} being operable to turn the pulse emission switch M_{DL} on or off based on a voltage level of the pulse emission switch gate driver signal GATE_{DL}.

In some examples, one or both of the fluxing switch M_{FLUX} and the pulse emission switch M_{DL} are implemented as Gallium Nitride (GaN) Field Effect Transistors (FETs). In other examples, one or both of the fluxing switch M_{FLUX} and the pulse emission switch M_{DL} are implemented as Silicon-based or Silicon-Carbide-based field-effect transistors (FETs).

Two or more components described herein as having terminals that are directly electrically connected have a DC current path between the respective terminals of the two or more components. For example, first and second components are not directly electrically connected via a capacitor or inductor connected in series between the first component and the second component.

The values of the input voltage Vᵢₙ, the inductance of the inductor Ls, and the capacitance of the source capacitor C_{Res} can advantageously be selected (“tuned”) to achieve a desired operation of the pulsed light-emitting diode driver 101 (e.g., a charge time, a pulse width, a pulse voltage, a pulse current). For example, a peak current and pulse width of the current i_{DL} flowing through the laser diode D_{L} can be tuned by adjusting the source voltage V_{CRes} on the source capacitor C_{Res} or the capacitance value of the source capacitor C_{Res}.

In some non-limiting examples, the regulated input voltage Vᵢₙ′ ranges from 10V to 200V, the inductance of the inductor Ls ranges from 50 nH to 1 uH, and the capacitance of the source capacitor C_{Res} ranges from 20 pF to 20 nF. However, it is understood that the voltage ranges and component values may be extended beyond the ranges provided based on design and application requirements.

The controller 120 may be integrated with the pulsed light-emitting diode driver 101, or it may be a circuit or module that is external to the pulsed light-emitting diode driver 101. As mentioned above, the controller 120 is operable to generate one or more gate drive signals having a voltage level that is sufficient to control any number of pulse emission switches M_{DL} and any number of fluxing switches M_{FLUX}. Additionally, the controller 120 is operable to sense a voltage and/or current at any of the nodes 110 and 112 and at nodes that are similar to, or the same as, the nodes 110 and 112 as described herein, or at still other nodes of the pulsed light-emitting diode driver 101. The optional controller 120 may include one or more timing circuits, look-up tables, processors, memory, or other modules to control the pulsed light-emitting diode driver 101.

The high-speed voltage detection module 122 disclosed herein utilizes an external high-voltage sense resistor R_{Sense} and a fast voltage-to-current converter that is described in detail below. In some examples, the external high-voltage sense resistor R_{Sense} is shown as being part of the high-speed voltage detection module 122, but it may be considered to be external thereto. Additionally, the high-speed voltage detection module 122 may be included as part of the controller 120, whereas the high-voltage sense resistor R_{Sense} may be external to the controller 120. The high-speed voltage detection module 122 is configured to advantageously allow for a high resistance value of the high-voltage sense resistor R_{Sense} to be used to limit current leakage and to reduce a voltage level of a sense voltage and/or a current amplitude of a sense current i_{Sense} received at the controller 120, among other benefits. In some examples, the resistance value of the sense resistor R_{Sense} is 1 MOhms to 30 MOhms, such as 6.2 MOhms, or 6.8 MOhms.

As shown, a first terminal of the high-voltage sense resistor R_{Sense} is electrically connected to a high-voltage node of a high-voltage domain at the node 112. As described below, in some examples the voltage detection module 122 advantageously regulates a second terminal of the high-voltage sense resistor R_{Sense} at sensing node 114 to a known reference voltage V_{Ref} (for example, 1.25V). Additionally, in some examples, the voltage detection module 122 is operable to blank a sensed voltage or current signal based on control/knowledge by the control logic and gate driver module 124 of when high dv/dt events occur in the driver 101 and/or when current sensing in the voltage detection module 122 occurs, so as to advantageously prevent misinformation due to the excess current needed to charge or discharge parasitic capacitance from the low-voltage sensing node 114 to the high-voltage node 112, ground, and/or to other nets of the driver 101.

As used herein, “blanking” refers to any action that inhibits the effect of a comparison output signal of the high-speed voltage detection module 122 during a defined interval, including (i) preventing the comparison output signal from being generated within the voltage detection module, (ii) preventing a generated comparison output signal from being output from the voltage detection module, or (iii) preventing a comparison output signal that has been output by the voltage detection module from being acted upon by downstream or receiving circuitry. In this context, one or more comparison output signals that are blanked may be intermediate comparison output signals within the voltage detection module, and/or aggregated comparison signals of the voltage detection module.

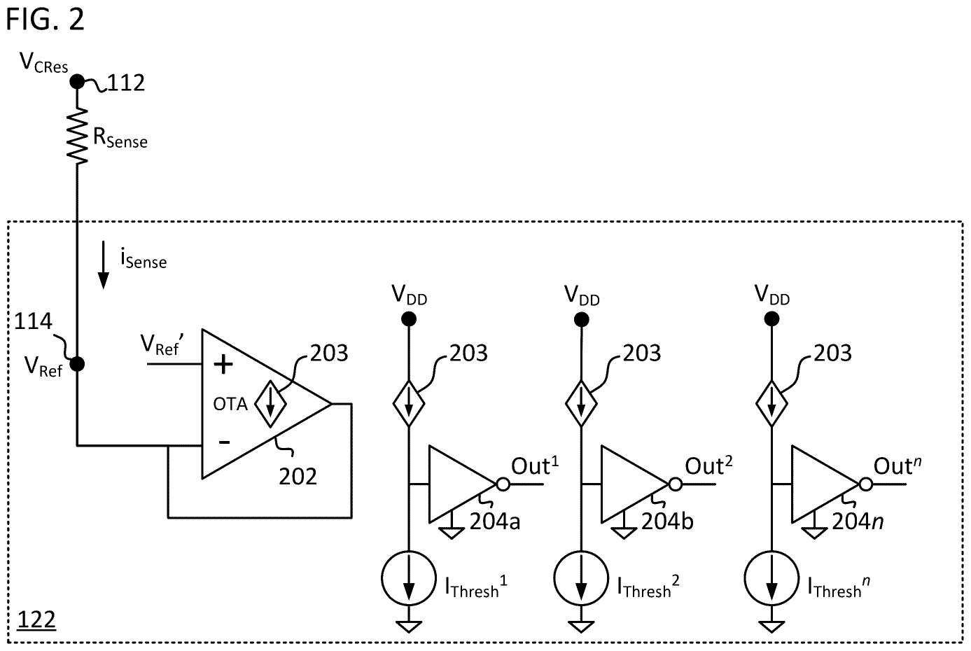

A first example implementation of a wide input range high-speed voltage detection module 122 is shown in FIG. 2, in accordance with some examples. The voltage detection module 122 includes a voltage-controlled current source (i.e., a voltage-to-current converter), such as a transconductance amplifier 202, n inverters 204a-n of a comparison network, and n fixed threshold current sources I_{Thresh}¹⁻ⁿ (e.g., current mirror circuits, digital-to-analog converters, etc.) of a reference network, connected as shown. The amplifier 202 is operable to receive a differential input voltage and to produce a proportional sensed current 203 based on the voltage difference. In the example shown, the differential input voltage is a difference between a configurable setpoint voltage V_{Ref}′ (e.g., generated by a digital-to-analog converter, a fixed power supply, a voltage regulator, etc. (not shown)) and the regulated low voltage reference voltage V_{Ref} developed at sensing node 114.

Since the current 203 is representative of the current i_{Sense} through the resistor R_{Sense}, in some examples, the current 203 may be placed across another resistor (not shown) to develop a lower positive voltage that is representative of the high positive and negative voltage net. In other examples, as shown, the current 203 may be compared to one or more other currents I_{Thresh}¹⁻ⁿ of the reference network by the inverters 204a-n of the comparison network in order to indicate that the voltage V_{CRes} on the high voltage net 112 has reached one or more thresholds.

In some examples, delays can be added before the system acts on any of the comparison outputs to better ensure the signal is not corrupted by transients or noise within the system.

As shown, the proportional sensed current 203 is received at a respective input node of each of the inverters 204a-n. Based on the respective threshold current level I_{Thresh}¹⁻ⁿ, the proportional sensed current 203 will cause a respective inverter of the inverters 204a-n to generate an asserted or de-asserted digital output level of the comparison output signals Out¹⁻ⁿ to indicate a comparison state.

For example, the current 203 is injected into an input terminal of the inverter 204a. If an amplitude of the current 203 surpasses the threshold current I_{Thresh}¹ sufficiently to exceed a threshold level of the inverter 204a, the output Out¹ of the inverter 204a will be de-asserted. Similarly, if the amplitude of the current 203 does not surpass the threshold current I_{Thresh}¹ sufficiently to exceed the threshold level of the inverter 204a, the output Out¹ of the inverter 204a will be asserted. By generating threshold current levels that are representative of voltage levels of interest for the driver 101 (e.g., an undervoltage threshold level, an overvoltage threshold level, a pre-charge level, a discharge level, etc.), a wide range of voltages at the high voltage net at the node 112 may be rapidly sensed using a low-voltage and high-gain sensing regime.

As shown in FIG. 1 and FIG. 2, the resistor R_{Sense} couples the high-voltage and sometimes negative-voltage net at the node 112 of a high-voltage domain to a low-voltage, positive-only input node 114 as an input to the high-speed voltage detection module 122 of a low-voltage domain. In a LiDAR or LED system, such as the driver 101, an output of the high-speed voltage detection module 122 may be used to regulate a specific voltage on the anode of the laser diode or LED D_{L}, or it can be used to sense whether there is an overvoltage or undervoltage condition, or other fault or condition, on any of the high voltage nets of the driver 101. For example, if one of the switches M_{FLUX} or M_{DL} are shorted, the high-speed voltage detection module 122 is operable to detect an undervoltage condition and communicate this state to the control logic and gate driver module 124 to thereafter rapidly react to prevent damage to other components or eye safety issues from the laser diode.

For example, if the high-speed voltage detection module 122 detects a short circuit across the pulse emission switch M_{DL}, the control logic and gate driver module 124 could enable the fluxing switch M_{FLUX}, which would then pull a large current from the voltage input supply Vᵢₙ and open a fuse or otherwise surpass a current limit protection feature in that path. Additionally, an output of the high-speed voltage detection module 122 may be used by the control logic and gate driver module 124 to detect and mitigate overvoltage or undervoltage conditions at specific points during operation of the driver 101. For example, the high-speed voltage detection module 122 may be configured to check for an overvoltage or undervoltage threshold condition after the source capacitor C_{Res} has been charged, but before pulse emission of the laser diode D_{L} has occurred. Based on a detected voltage, the control logic and gate driver module 124 may cease operation in order to avoid further damage, or it may determine that it should not emit a pulse from the laser diode D_{L} if the detected voltage is too high, or may enable the fluxing switch M_{FLUX} to further charge the source capacitor C_{Res} if the detected voltage is too low. Additionally, based on the detected voltage, the control logic and gate driver module 124 may check for a different overvoltage threshold after pulse emission by the laser diode D_{L} and before the source capacitor C_{Res} has been charged.

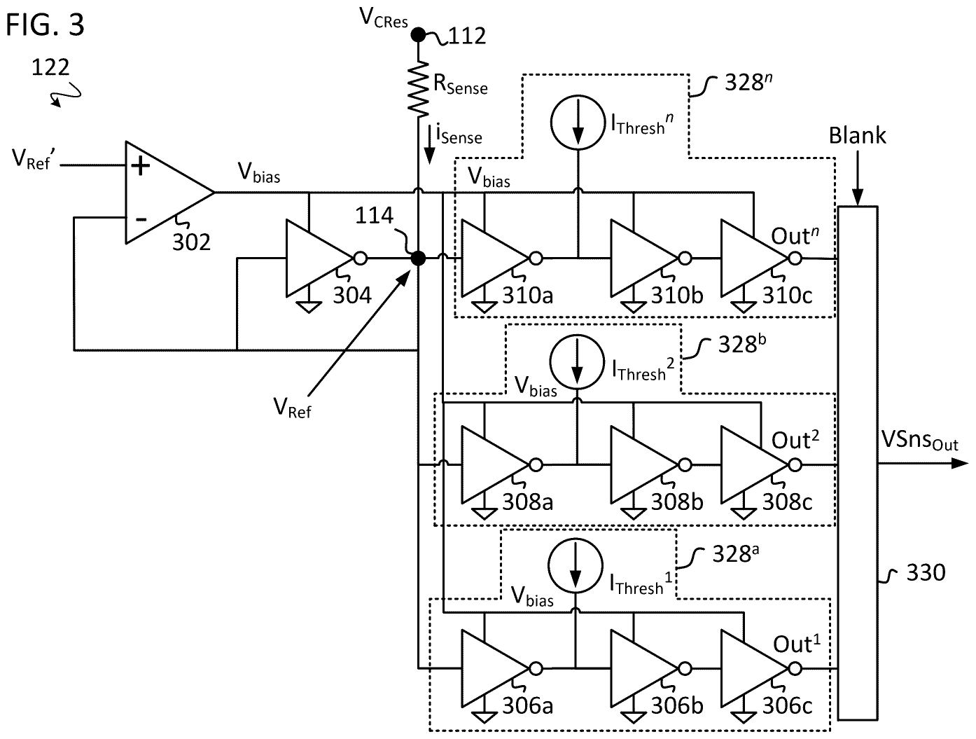

FIG. 3 illustrates a second example implementation of a high-speed voltage detection module 122 introduced with reference to FIG. 1. In general, the high-speed voltage detection module 122 includes an operational amplifier (“op-amp”) circuit 302, a reference inverter 304, a comparison network that includes a first set of threshold detection inverters 306a-c of a first signal comparison block 328ª, a second set of threshold detection inverters 308a-c of a second signal comparison block 328h, and an n^{th} set of threshold detection inverters 310a-c of an n^{th} signal comparison block 328″, and an optional output logic and blanking circuit 330, connected as shown. Also shown is the voltage sense resistor R_{Sense}, nodes 112 and 114, the voltage sense signal V_{CRes}, the current sense signal i_{Sense}, a reference network that includes a first threshold current I_{Thresh}¹, a second threshold current I_{Thresh}², and an n^{th} current threshold I_{Thresh}ⁿ, an optional blanking signal Blank (e.g., generated by the control logic and gate driver module 124), voltage comparison output signals Out¹⁻ⁿ, and an aggregated output voltage comparison output signal VSns_{Out}. Some components have been omitted to simplify the description herein, but are understood to be present.

A first terminal of the sense resistor R_{Sense} is electrically connected to the node 112 shown in FIG. 1 to receive the source voltage V_{CRes}. The op-amp circuit 302 receives a configurable setpoint voltage V_{Ref}′ (e.g., from the control logic and gate driver module 124, from a digital-to-analog converter, a configuration pin, etc.) and adjusts, via a feedback loop, the bias or rail voltage V_{bias} of the reference inverter 304 such that a regulated reference voltage V_{Ref} at the low voltage node 114 is equal to the setpoint voltage V_{Ref}′.

As shown, the reference inverter 304 is configured such that the input of the reference inverter 304 is shorted to its output. As is known in the art, the output of the reference inverter 304 will therefore reach a steady state voltage level of the reference voltage V_{Ref} that is equal to the threshold voltage level of the inverter 304 (e.g., roughly

$$\frac{{V}_{b i a s}}{2}$$

for an inverter with equal strength P-type and N-type devices, or a large variation of voltage levels between V_{bias} and zero volts, depending on the Vth or Vbe and strength of the P-type and N-type devices used in the inverter). In the example shown, the op-amp circuit 302 is operable to adjust the bias voltage V_{bias} until the regulated reference voltage V_{Ref} is equal to the setpoint voltage V_{Ref}′.

The input and output of the reference inverter 304 are electrically connected to a terminal of the sense resistor R_{Sense} at node 114. The other terminal of the sense resistor R_{Sense} is connected to node 112 to receive the voltage V_{CRes} that is to be sensed/compared. The sense current i_{Sense} is therefore developed based on the voltage across the sense resistor R_{Sense} and can be calculated as

$${i}_{S e n s e} = \frac{{V}_{C Res} - {V}_{R e f}}{{R}_{S e n s e}} .$$

Following the reference inverter 304, the voltage detection module includes one or more of the signal comparison blocks 328^{a-n}, each having one or more PFET/NFET proportioned inverters that have identical, or nearly identical, threshold voltages. Each of the comparison blocks may be advantageously used to rapidly detect a different threshold voltage level of the source voltage V_{CRes}. In some examples, inverters of the one or more of the signal comparison blocks 328^{a-n} may include inverters of differing fractions or multiples in size relative to the reference inverter 304 to produce a desired current gain or current reduction within a signal chain of a respective comparison block.

For each of the one or more of the signal comparison blocks 328^{a-n}, an associated voltage detection threshold level is set by injecting a representative threshold current level into the signal chain. The associated threshold level may be representative of an overvoltage level, an undervoltage level, an indication of a charge state or level of the source capacitor C_{Res}, etc. In some examples, each of the current threshold levels are generated using a current mirror circuit, a transconductance amplifier circuit, a digital-to-analog converter, or another appropriate circuit for generating a configurable current level. In some examples, the inverters 306b, 308b, and 310b can each be replaced with a different type of comparator circuit to sense when the output of inverters 306a, 308a or 310a go above or below a voltage threshold level (for example,

$$\frac{{V}_{b i a s}}{2} ) ,$$

and the inverters 306c, 308c and 310c can be kept or removed.

For example, a threshold current I_{Thresh}¹ is injected into the output of the inverter 306a of the comparison block 328ª. As was functionally illustrated in FIG. 2, if the threshold current I_{Thresh}¹ is less than the output current of the inverter 306a (which is proportional to the sense current i_{Sense}), the output of the inverter 306a will be pulled above the threshold level of the inverter 306b, bringing an output of the inverter 306b low and an output Out¹ of the inverter 306c high.

Similarly, if the threshold current I_{Thresh}¹ is greater than the output current of the inverter 306a (which is proportional to the sense current i_{Sense}), the output of the inverter 306a will be pushed below the threshold level of the inverter 306b, bringing the output of the inverter 306b high and the output Out¹ of the inverter 306c low.

The optional output logic circuit 330 is operable to receive each of the comparison output signals Out¹⁻ⁿ and to generate an aggregated output voltage comparison signal VSns_{Out}. The aggregated output voltage comparison signal VSns_{Out} may be a digital representation of a sensed voltage, an analog representation of the sensed voltage (e.g., in an example in which a respective output current of one or more of the inverters 306a, 308a, and/or 310a is directed through a respective resistor coupled to ground (not shown) and to the output logic circuit 330 in lieu of the inverters 306b-c, 308b-c, and 310b-c in order to develop a lower positive voltage that is representative of the high positive and negative voltage net at the node 112), a signal that is proportional to the sensed voltage, one or more binary outputs, or may simply pass through the voltage comparison output signals Out¹⁻ⁿ.

The aggregated output voltage comparison signal VSns_{Out} is received in some examples by the control logic and gate driver module 124 shown in FIG. 1 and may be used thereby to control pulse emission timing, to detect an operating state, and/or a fault condition of the laser diode driver circuit 101. In some examples, the output logic circuit 330 is operable to receive the blanking signal Blank from the control logic and gate driver module 124 so as to only generate the aggregated output voltage comparison signal VSns_{Out} during desired times of the pulse emission switching cycle of the laser diode driver circuit 101. For example, in some scenarios, the blanking signal Blank is configured to prevent output from the voltage detection module 122 when the source voltage V_{CRes} is changing rapidly to prevent misinformation due to the excess current needed to charge or discharge parasitic capacitance from the low voltage sensing node 114 to the high voltage node 112 or from ground to other nodes within the driver circuit 101 and/or the voltage detection module 122. In some examples, the blanking signal Blank is generated by the control logic and gate driver module 124 based on knowledge thereof of which portions of a switching cycle should be blanked or based on a sensed current amplitude level of the sense current signal i_{Sense}.

A different blanking window may be used for each of the I_{Thresh} sense levels I_{Thresh}¹⁻ⁿ, with variations on the time window for sensing the voltages including blanking when the laser diode D_{L} is fired; blanking when the source capacitor C_{Res} is being charged; blanking for an amount of time after pulse emission from the laser diode D_{L}; or blanking after the source capacitor C_{Res} is charged in order to allow the source capacitor voltage V_{CRes} to return to a fixed value and the voltage detection module 122 to deplete any parasitic capacitor current. Additionally, the time window may involve blanking after some amount of time has elapsed after pulse emission (e.g., blanking starting 1 us after the laser diode D_{L} has fired) in case leakage current is reducing the source capacitor voltage V_{CRes}.

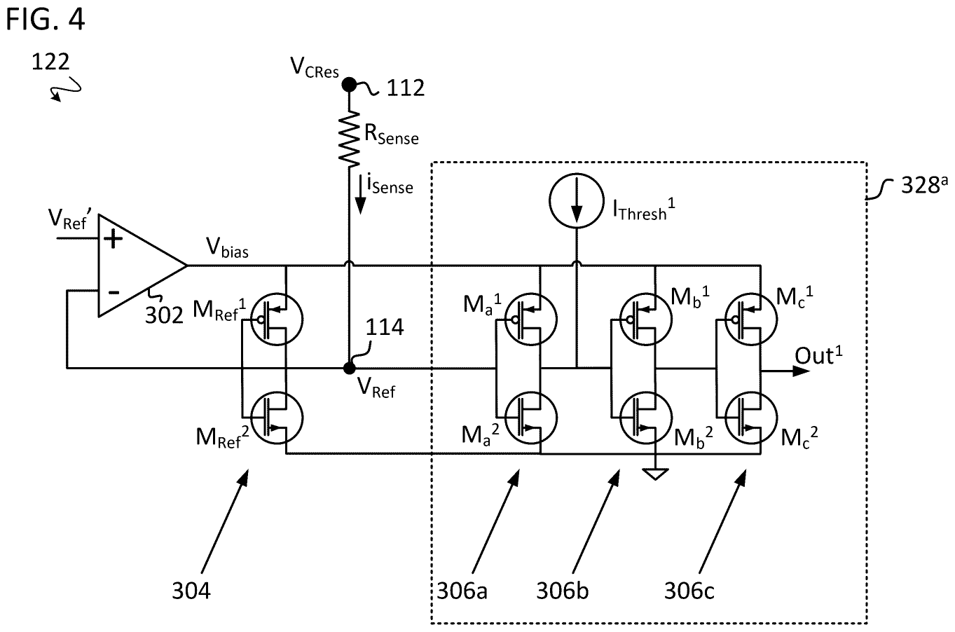

An example implementation of the reference inverter 304 and the comparison block 328ª are shown in FIG. 4, in accordance with some examples. As shown, the reference inverter 304 includes a PFET/NFET pair M_{Ref}¹⁻², the inverter 306a includes a PFET/NFET pair Mₐ¹⁻², the inverter 306b includes a PFET/NFET pair M_{b}¹⁻², and the inverter 306c includes a PFET/NFET pair M_{c}¹⁻².

For simplicity, all of the inverters 304 and 306a-c are shown as being identical. At steady state, for ideally matched inverter stages and in the absence of any sense current i_{Sense} or threshold current I_{Thresh}¹ or noise within the system, all of the inverters 306a-c will mirror the input to output shorted reference inverter 304 and will all remain at steady state with their inputs and outputs being equal to the threshold voltage of the reference inverter 304.

Changing the output state of Out¹ of the inverter 306c to low from high requires that the NFET Mₐ² in the inverter 306a pulls down an additional I_{Thresh}¹ amount of current. Because the NFET M_{Ref}² in the reference inverter 304 forms a current mirror with the NFET Mₐ² in the inverter 306a, when an amplitude of the sense current i_{Sense} received by the NFET M_{Ref}² of the reference inverter 304 (i.e., from node 114) exceeds the threshold current I_{Thresh}¹, an identical mirrored current through the NFET Mₐ² will overpower the threshold current I_{Thresh}¹ being pulled out of the output of inverter 306a, thereby flipping the output of the inverter 306b high, and the output of the inverter 306c low. Depending on design requirements, the number of inverters in each comparison block may vary to change the gain of the comparator and/or polarity.

Static current is mostly determined only by cross-conduction of the first few inverter stages within each comparison block as later stages within a given comparison block are mostly fully switched CMOS inverters, which do not consume any current. The static current is also affected by how far above a PFET plus an NFET's threshold voltage that the bias voltage V_{bias} is regulated to. As shown, since each comparison block is fully PFET/NFET symmetrical, each comparison block may advantageously equally compare negative voltages via the sense current i_{Sense} mirroring into the PFETs of each inverter rather than into the NFETs thereof. Additionally, the use of inverters as the comparator/amplification chain is advantageously generally much faster for the same amount of current and much more symmetric in rise vs fall delays as compared to conventional analog amplifiers that may be used for comparing received currents.

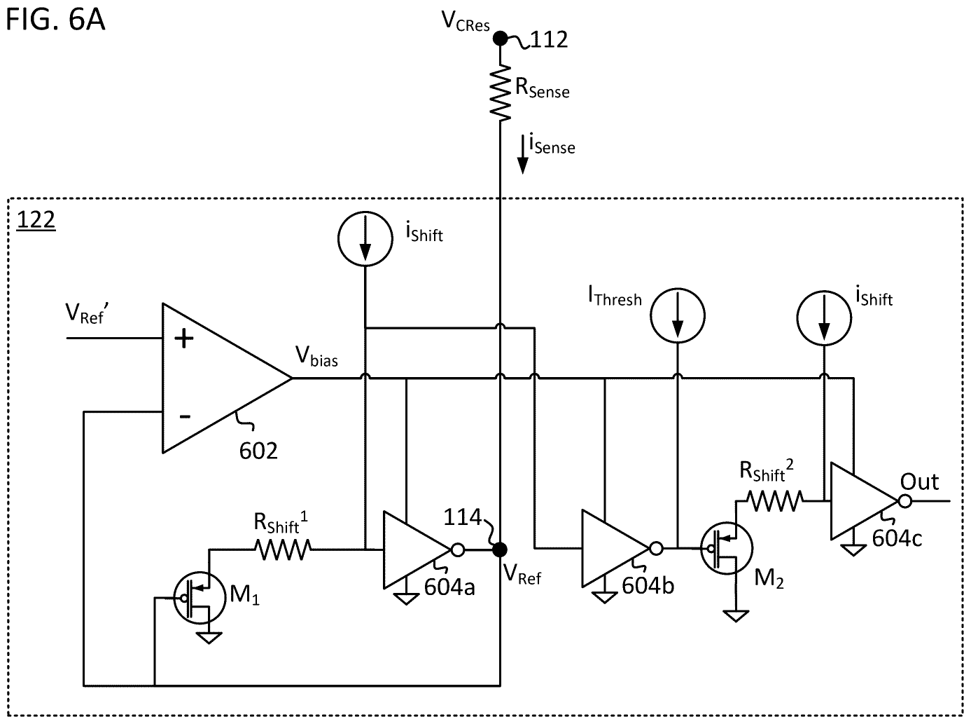

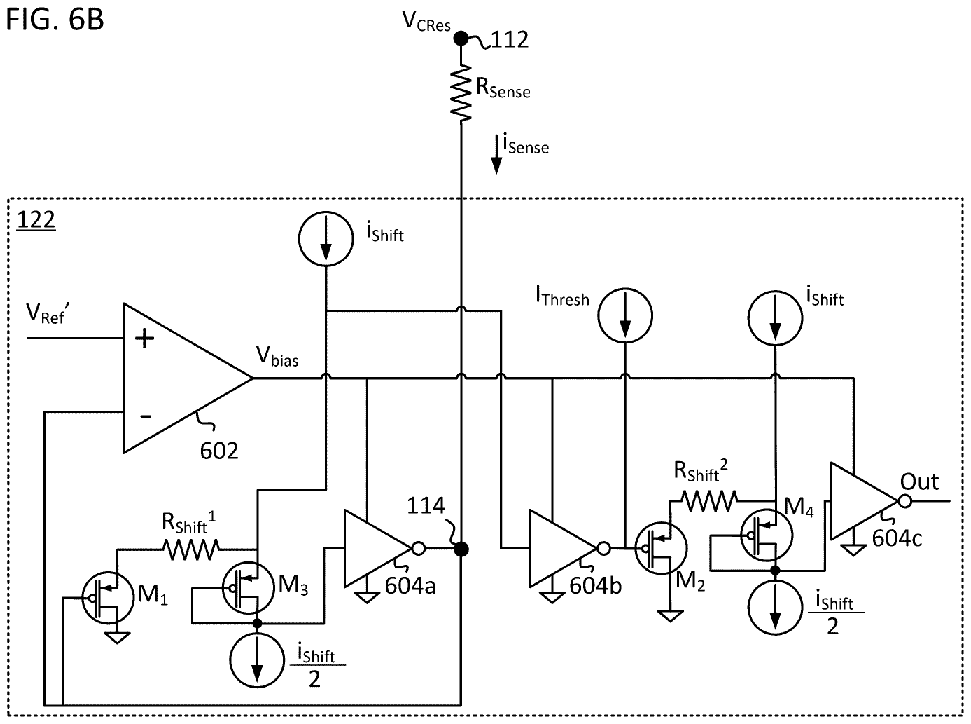

In some examples, the reference inverter 304 output may be level-shifted to the input to allow for a lower voltage at the node 114 (as shown in FIGS. 6A-B), which in turn results in a lower leakage current to ground, as compared to non-level-shifted solutions. The level shifting may be accomplished using a source follower circuit and/or using a capacitor in order to achieve a very low current on the inverter drain, and/or using a resistor on other current carrying elements and canceling out the current through that element.

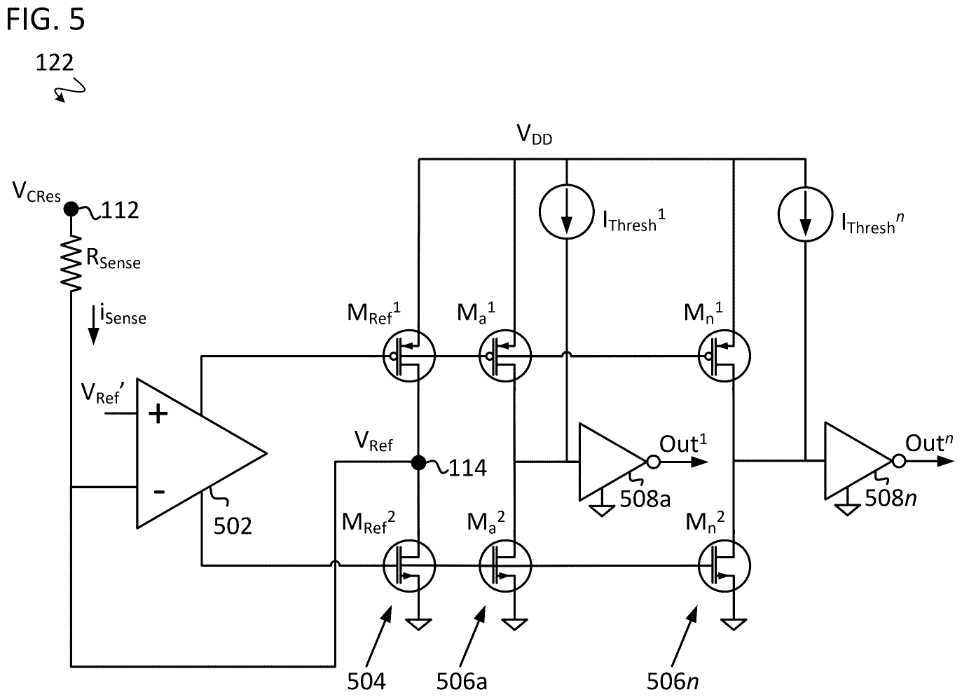

A third example implementation of the high-speed voltage detection module 122 is illustrated at a high level in FIG. 5, in accordance with some examples. In the example shown, a different implementation of a transconductance amplifier (“op-amp” 502) advantageously enables V_{Ref} to be of a wide range of voltages to within a few hundred millivolts of both a rail voltage of the op-amp 502 and ground. In the example shown, the high-speed voltage detection module 122 includes an op-amp 502, a reference inverter 504 that includes a PFET/NFET pair M_{Ref}¹⁻², a first inverter 506a that includes a PFET/NFET pair Mₐ¹⁻², an n^{th} inverter 506n that includes a PFET/NFET pair Mₙ¹⁻², comparison network that includes a first output inverter 508a having a comparison output signal Out¹ and an n^{th} output inverter 508″ having a comparison output signal Outⁿ, and n fixed threshold current sources I_{Thresh}¹⁻ⁿ of a reference network, connected as shown. Also shown are the sense resistor R_{Sense}, the sense current i_{Sense}, the source voltage V_{CRes}, the setpoint voltage V_{Ref}′, and the nodes 112 and 114.

In some examples, electrostatic discharge (ESD) protection is incorporated in the inverter circuits of the high-speed voltage detection module 122 such that any leakage current is canceled out. In some examples, the ESD protection is accomplished by using significantly larger inverters as compared to non-ESD protected inverters to advantageously preclude the need for additional ESD circuitry. In other examples, ESD protection is achieved with additional resistance included in the drain or source of the inverter devices using either additional space from gate to contacts (sometimes blocking the silicide in that region) or by using actual physical resistors.

A fourth example implementation of a wide input range high-speed voltage detection module 122 is shown in FIG. 6A. In the example shown, the voltage detection module 122 advantageously allows the inverter input level to be below (or above if an N-type source follower is used instead of a P-type source follower) the inverter output with minimal loss to the speed of the circuit. In the example shown, the voltage detection module 122 includes an operational amplifier (“op-amp”) 602, source-follower transistors M₁ and M₂, inverters 604a-c of a comparison network, the setpoint voltage V_{Ref}′, an inverter bias or rail voltage V_{bias} generated by the op-amp 602, a sense current i_{Sense} generated through the sense resistor R_{Sense} based on the source voltage V_{CRes} at node 112, node 114, a reference network having a threshold current I_{Thresh}, optional level-shift resistors R_{Shift}¹⁻², a level-shift current i_{Shift}, and an output signal Out. In the example shown, the inverter bias voltage V_{bias} is generated and regulated by the op-amp 602 such that the respective inverter threshold voltages of the inverters 604a-c are equal to the setpoint voltage V_{Ref}′. Thereafter, the sense current i_{Sense} is effectively compared to the threshold current I_{Thresh} by the inverter 604c to generate a comparison output signal Out. Since the inverter inputs are quite high impedance (poly gates), the optional level-shift resistors R_{Shift}¹⁻² can be added, as part of a level-shift network, to further shift the voltage between the inverter inputs and outputs. If the level-shift resistors R_{Shift}¹⁻² were instead connected from the emitter of the source follower devices M₁₋₂ to a current sink and to the input of the inverters, then the voltage from the source of the source followers could be shifted down across the resistor to a lower potential. The source follower transistors M₁₋₂ can be standard PMOS devices or low threshold voltage devices with their well connected to their source or to a supply voltage. Also, N-type source followers could be used (with the level-shift current i_{Shift} being a current sink rather than a current source) in order to provide an inverter input voltage that is lower than the inverter output voltage.

Using the circuit of FIG. 6A, a reference voltage V_{Ref} that is much lower than the threshold voltage of the NMOS devices in the inverters 604a-c may advantageously be used, which may significantly reduce the leakage current from V_{Ref} at node 114 to ground.

A fifth example implementation of a wide input range high-speed voltage detection module 122 is shown in FIG. 6B. The implementation shown in FIG. 6B is an alternative to the circuit shown in FIG. 6A, in that the voltage to the respective inputs of the inverters 604a and 604c is shifted up by a level-shift network that includes a respective P-type source follower circuit M₁ and M₂, and a level-shift resistor R_{Shift}¹ and R_{Shift}², but back down through a respective diode-connected P-type transistor M₃ and M₄. This configuration can provide a more accurate shift voltage between the inverter input and output that is simply based on a current through a resistor. Additional variations to this using N-type transistors and sink or source currents through the resistors can be used to achieve a large range of accurate up and down shift voltages with very little loss to the speed of the circuit.

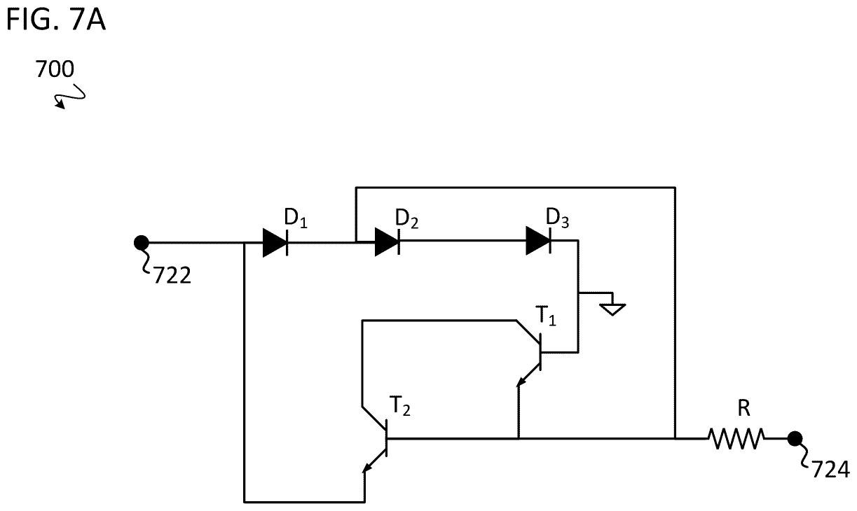

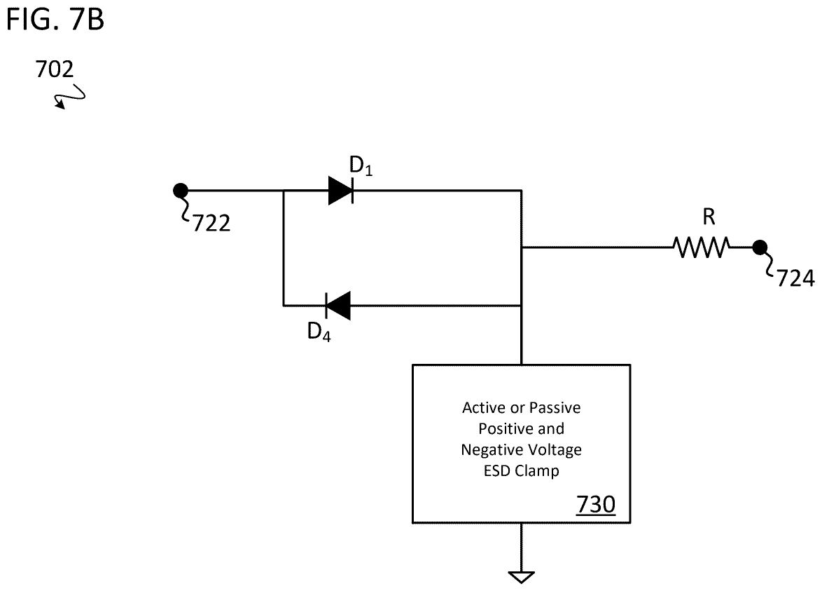

An example of a low-voltage ESD protection circuit 700 for use in the high-speed voltage detection module 122 is illustrated in FIG. 7A, in accordance with some examples. In the example shown, the ESD protection circuit 700 includes transistors T₁₋₂, ESD protection diodes D₁₋₃, an optional resistor R (for ESD protection for the node 724), and nodes labeled 722 and 724, connected as shown. In some examples, either or both transistors T₁ and T₂ could be replaced with diodes and any or all of diodes D₁₋₃ can be replaced with transistors. In some examples, the node 722 is electrically connected to the reference voltage node 114 (e.g., through a resistor, not shown) and the node 724 is electrically connected to a bias voltage that is equal to the reference voltage at the node 114 (not shown).

The ESD protection circuit 700 is operable to clamp both positive and negative voltages and to connect node 724 to the setpoint voltage V_{Ref}′ (i.e., the reference voltage used to set the voltage V_{Ref} on the node 722 (via the op-amp circuit shown in previous figures). During normal operation of the high-speed voltage detection module 122, the node 724 is shorted to the internal setpoint voltage V_{Ref}′. Since the voltage at the node 722 is regulated to the same potential as the internal setpoint voltage V_{Ref}′, the voltage difference across the diode D₁ and the base emitter junction of transistor T₂ will be very close to zero volts; therefore, the leakage current from the anode of D₁ and the emitter of T₂ to the node 722 will be extremely low and will likely go to zero volts and change polarity after only a few millivolts of change to the voltage at the node 722 (as it becomes slightly higher or lower voltage than that of the node 724).

Another example of a low-voltage ESD protection circuit 702 for use in the high-speed voltage detection module 122 is illustrated in FIG. 7B, in accordance with some examples. In the examples shown, the diodes D₂, D₃ and the transistor T₁ can be replaced with a diode D₄ and an active or passive ESD protection device 730 that is operable to clamp to an acceptable positive and negative voltage during an ESD strike and to also provide a high impedance when shorted to the node 724 during normal operation. For example, if the positive and negative clamping circuit 730 were to clamp the positive voltage during an ESD strike to +3V above ground and clamp the negative voltage to −1V below ground and diodes D₁ and D₄ each clamp to a forward voltage of 1V during an ESD strike, then the node 722 would be clamped to a forward voltage of 4V above ground during a positive ESD strike and would also be clamped to a negative voltage of −2 below ground during a negative ESD strike; during normal operation, if the node 724 was forced to an internal reference voltage of 1.25V and the node 722 was regulated via a transconductance amplifier to a voltage of 1.25V, then the voltage across diodes D₁ and D₄ would be very near to zero volts, and the leakage across those diodes would therefore be extremely low (for example <100 pA).

Those skilled in the art may easily appreciate that this circuit can be extended as an extremely low leakage current ESD protection circuit for almost any integrated circuit node (e.g., an external pin). For example, if the active or passive ESD clamp were to clamp during a positive ESD strike to 6V above ground and during a negative ESD strike to 1V below ground and the diodes D₁ and D₄ clamped to a forward voltage of 1V each during the ESD strike, then the ESD protection circuit 702 could be used to protect a zero to 5V node, limiting its voltage during a positive ESD strike to +7V above ground and limiting its voltage during a negative ESD strike to −2V below ground. If that node had circuitry with diodes to ground and a 5V supply, then a series resistance could be placed between the node and that circuitry to limit the current to an acceptable level during an ESD strike (with or without secondary ESD protection on the circuitry side of the additional resistor). During normal operation, the voltage could be sensed on the node 722 in order to internally regulate the node 724 to that same voltage and achieve very near to zero volts across the diodes D₁ and D₄.

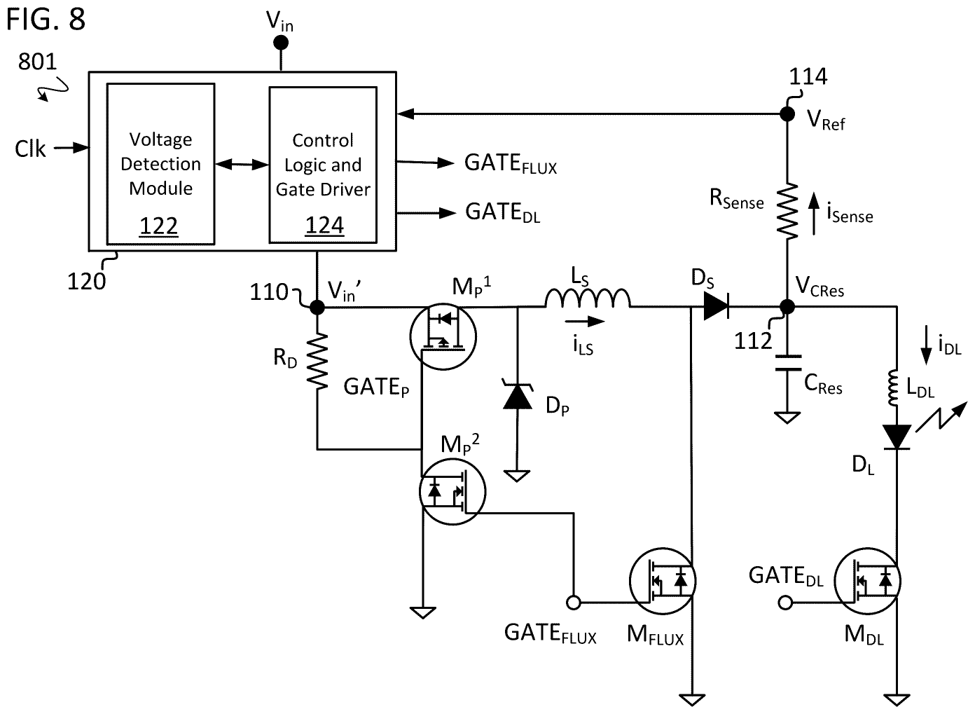

Additional protection circuits to mitigate damage caused by fault conditions, such as overvoltage, undervoltage and/or short conditions within the LED and/or laser diode driver circuits are disclosed herein. FIG. 8 provides an example of a laser diode driver 801 that is similar to the laser diode driver 101, but includes additional protection circuitry, in accordance with some examples. The driver 801 includes all of the elements of the driver 101, but additionally includes protection switches M_{P}¹⁻², a protection diode D_{P}, and a resistor R_{D}, connected as shown. Any of the example implementations of the high-speed voltage detection module 122 disclosed herein are operable for use in the context of the driver 801.

In the example shown, the driver 801 is configured to turn off a series connected PFET switch M_{P}¹ via gate control signal GATE_{P} to interrupt a current path from the input voltage node 110 to the inductor Ls. In the example shown, the NFET M_{P}² is controlled with the fluxing switch gate control signal GATE_{FLUX}. After the fluxing switch gate control signal GATE_{FLUX} goes low (to ground), the resistor R_{D} prevents the PFET switch M_{P}¹ from turning off until the source capacitor C_{Res} is fully charged (based on an appropriately sized value of the resistor Rp and the gate capacitance of switch M_{P}¹). In order to ensure that the gate to source capacitance of M_{P}¹ is sufficiently higher than the gate to drain capacitance, an optional external capacitor (not shown) can be placed in parallel with the resistor R_{D}. However, during a voltage fault condition, such as a short across the pulse emission switch M_{DL}, the protection diode D_{P} will prevent the drain of the PFET M_{P}¹ from going sufficiently below ground and damaging the PFET switch M_{P}¹.

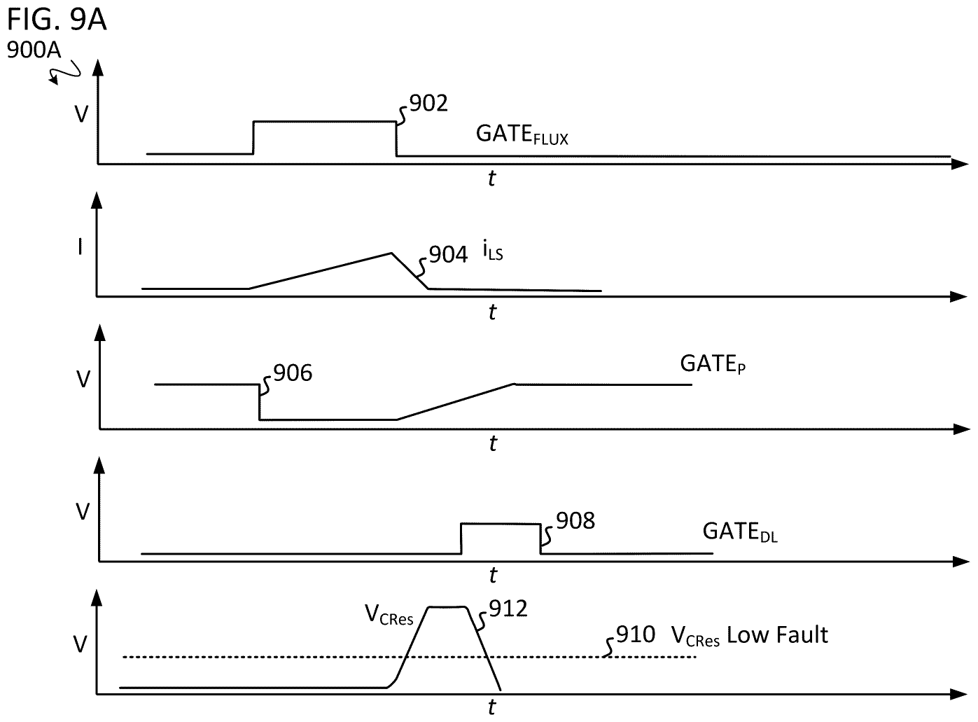

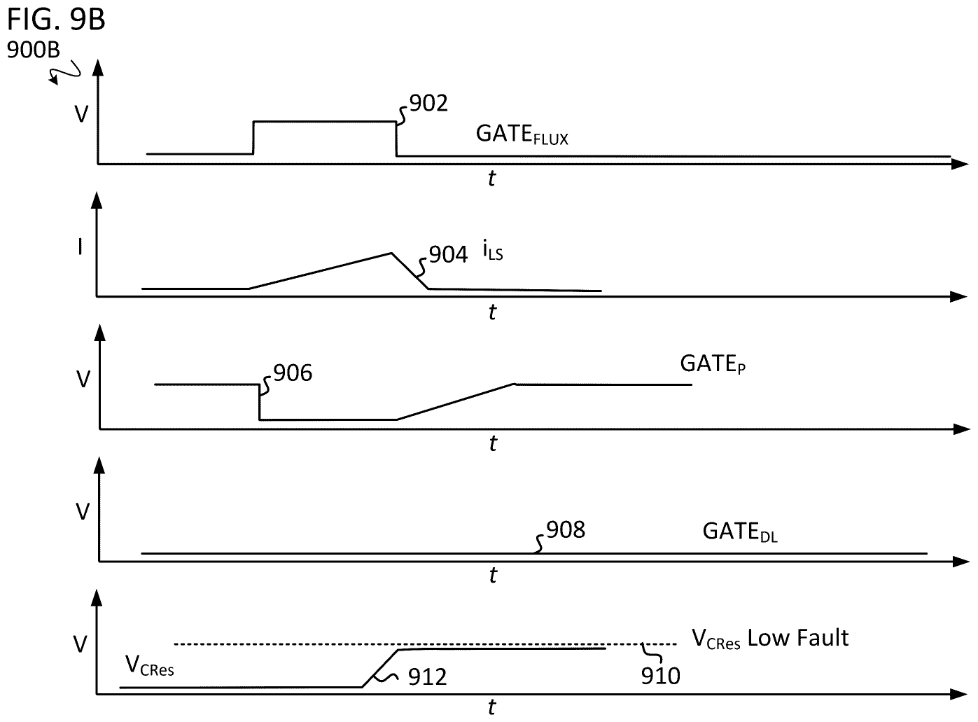

To elaborate, FIGS. 9A-B show example plots 900A-B of signals related to the operation of the driver 801 shown in FIG. 8, in accordance with some examples. The signals shown include the fluxing switch gate driver signal GATE_{FLUX} 902, the inductor current its 904, a gate-source voltage level GATE_{P} 906 for the PFET M_{P}¹, the pulse emission switch gate driver signal GATE_{DL} 908, a low-voltage threshold level “V_{CRes} Low Fault” 910 for the source voltage V_{CRes}, and the source voltage V_{CRes} 912.

In the examples shown in FIGS. 9A-B, the inductor current i_{LS} 904 begins to fall towards zero volts, and the voltage level of GATE_{P} 906 for the PFET M_{P}¹ begins to rise when the fluxing switch M_{FLUX} is disabled by a de-asserted level of the fluxing switch gate driver signal GATE_{FLUX} 902. However, as shown in FIG. 9B, if there is a short circuit condition, the source voltage V_{CRes} 912 will not meet or exceed the V_{CRes} Low Fault voltage level 910 and the driver 801 will advantageously no longer charge the source capacitor C_{Res} or cause pulse emission from the laser diode D_{L} due to that fault.

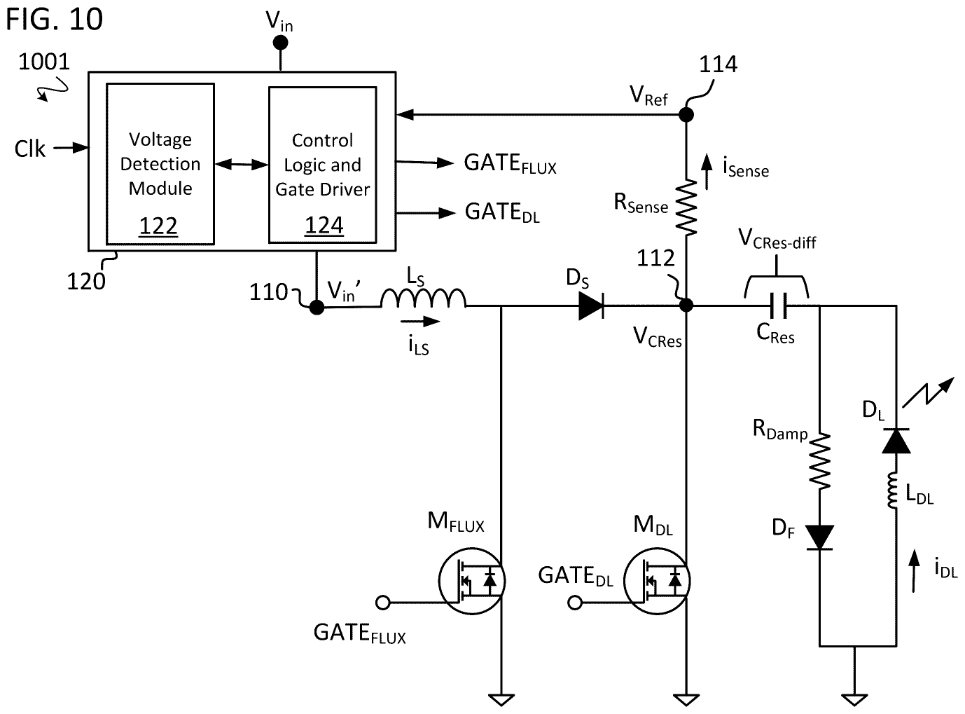

FIG. 10 provides an example of a laser diode driver 1001 that is similar to the laser diode driver 101, but eliminates the need for undervoltage protection circuitry for a shorted switch M_{DL}, in accordance with some examples. The driver 1001 includes all of the elements of the driver 101, but additionally includes a series combination of an optional damping resistor R_{Damp} and a diode D_{F} in parallel with the series combination of the laser diode D_{L}, and the pulse emission switch M_{DL}. Also shown is a differential voltage V_{CRes-diff} developed across the source capacitor C_{Res}. In the example shown, the driver 1001 will automatically prevent pulse emission of the laser diode D_{L} if the pulse emission switch M_{DL} is shorted. Any of the example implementations of the high-speed voltage detection module 122 disclosed herein are operable for use in the context of the driver 1001.

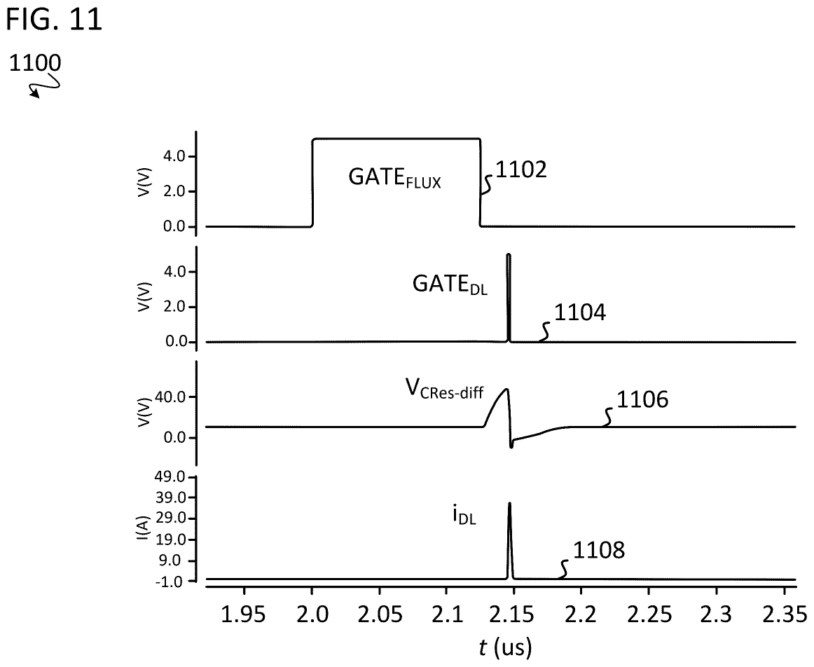

FIG. 11 shows example plots 1100 of signals related to the operation of the driver 1001 shown in FIG. 10, in accordance with some examples. The signals shown include the fluxing switch gate driver signal GATE_{FLUX} 1102, the pulse emission switch gate driver signal GATE_{DL} 1104, the voltage V_{CRes-diff} 1106, and the current through the laser diode i_{DL} 1108.

With reference to FIG. 10 and FIG. 11, when the fluxing switch gate driver signal GATE_{FLUX} 1102 is asserted and the fluxing switch M_{FLUX} is enabled, inductor current its through the inductor Ls will ramp up. When the fluxing switch gate driver signal GATE_{FLUX} 1102 is de-asserted and the fluxing switch M_{FLUX} is disabled, the diode D_{S} allows the inductor current its to flow to the source capacitor. Since the diode D_{F} will limit the voltage at the cathode of the laser diode D_{L} to a diode drop above ground (plus any resistive drop in D_{F} or the optional resistor R_{DAMP}), the voltage V_{CRes-diff} 1106 across the source capacitor C_{Res} will charge to a high value (for example 80V). When the pulse emission switch gate driver signal GATE_{DL} 1104 is asserted and the pulse emission switch M_{DL} is enabled, the terminal of the source capacitor C_{Res} that is connected to a drain node of the pulse emission switch M_{DL} will be shorted to ground and the terminal of the source capacitor C_{Res} connected to the cathode of the laser diode D_{L} will try to go below ground and therefore forward bias the laser diode D_{L}. Upon being forward biased, the diode current i_{DL} 1108 will begin to flow through the laser diode D_{L}, and light pulse emission occurs. However, if there is a short circuit across either of the switches M_{FLUX} and/or M_{DL}, the source capacitor C_{Res} will never be charged, and so the laser diode D_{L} will advantageously not become forward biased and no current will flow through it.

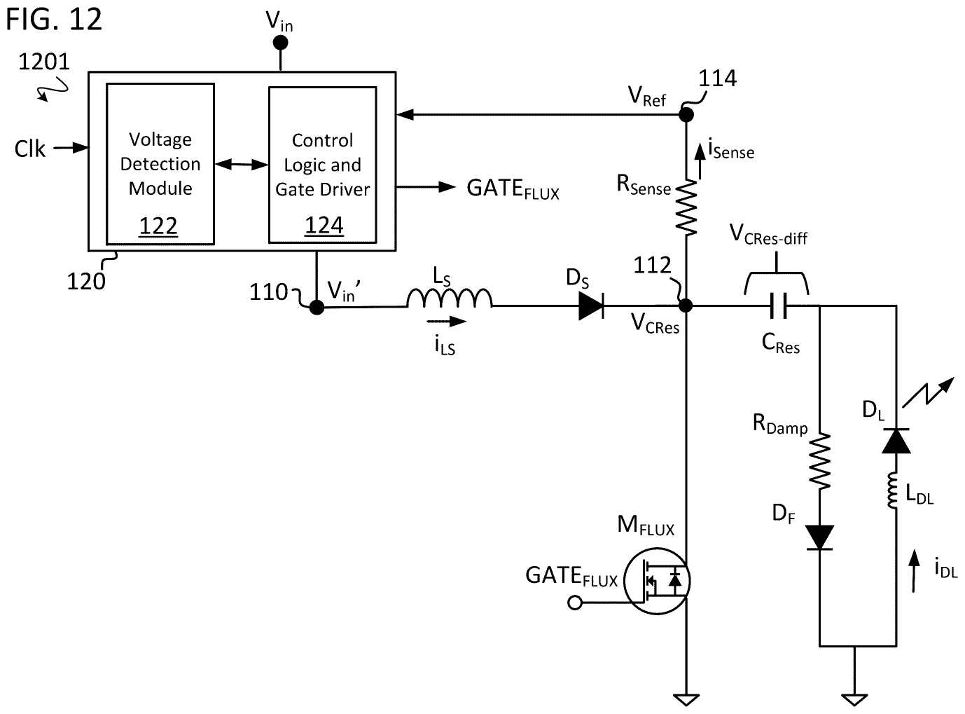

In order to eliminate the need for undervoltage protection circuitry for a shorted pulse emission switch M_{DL}, FIG. 12 provides another example of a laser diode driver 1201 that is similar to the laser diode driver 1001, but which advantageously eliminates the need for the pulse emission switch M_{DL}, in accordance with some examples. As shown, the driver 1201 includes all of the elements of the driver 1001, but also eliminates the pulse emission switch M_{DL} and instead is configured such that a drain node of the fluxing switch M_{FLUX} is directly electrically connected to a first terminal of the source capacitor C_{Res}, a second terminal of which being connected to the cathode of the laser diode D_{L}. In the example shown, the driver 1201 will automatically prevent pulse emission of the laser diode D_{L} if the fluxing switch M_{FLUX} is shorted. Any of the example implementations of the high-speed voltage detection module 122 disclosed herein are operable for use in the context of the driver 1201.

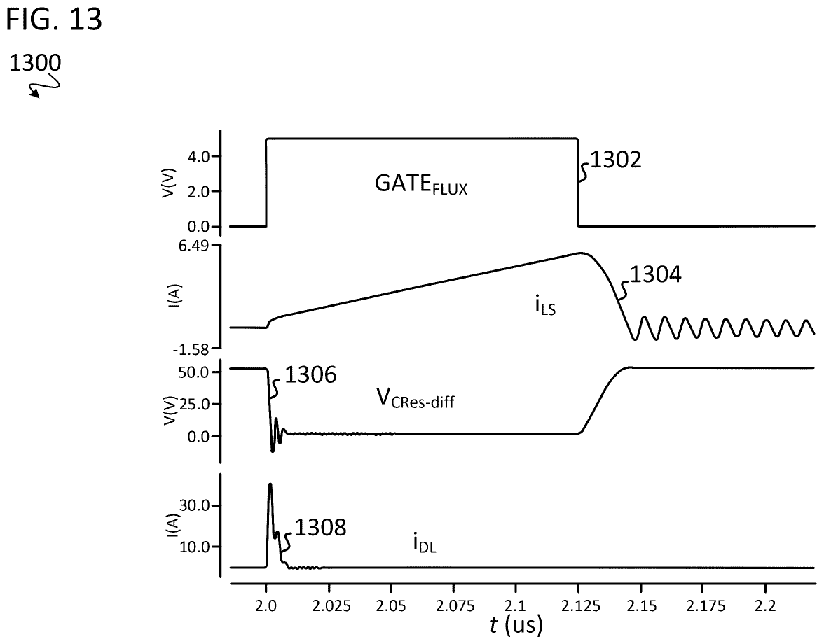

FIG. 13 shows example plots 1300 of signals related to the operation of the driver 1201 shown in FIG. 12, in accordance with some examples. The signals shown include the fluxing switch gate driver signal GATE_{FLUX} 1302, the current i_{LS} 1304 through the inductor Ls, the voltage V_{CRes-diff} 1306, and the current i_{DL} 1308 through the laser diode D_{L}.

When the GATE_{FLUX} signal 1302 is activated, the laser current i_{DL} 1308 pulses, firing the laser diode D_{L}. Since the GATE_{FLUX} signal 1302 remains activated, the current i_{LS} 1304 through the inductor Ls continues to rise. When the GATE_{FLUX} signal 1302 is deactivated, the current its 1304 from the inductor LS charges the voltage V_{CRes-diff} 1306 across the source capacitor C_{Res} such that the laser diode D_{L} can be fired the next time the GATE_{FLUX} signal 1302 is activated.

Because the current its 1304 through the inductor Ls will ramp when pulse emission through the laser diode D_{L} occurs, the driver 1201 advantageously keeps the fluxing switch M_{FLUX} in an enabled state in order to develop enough current to fully charge the source capacitor C_{Res}. A downside to the configuration shown in FIG. 12 is that the source capacitor C_{Res} could be partially discharged by leakage current before subsequent pulse emission of the laser diode D_{L}, particularly if the frequency of light pulse emission is relatively low (for example, <50 kHz). However, the configuration shown in FIG. 12 advantageously does not charge the source capacitor C_{Res} if there is a short across the fluxing switch M_{FLUX}.

To mitigate leakage current from the source capacitor C_{Res} before pulse emission, in some examples, the GATE_{FLUX} signal 1302 may be deactivated very quickly during or after laser firing such that the current i_{LS} 1304 in the inductor Ls is quite low. Upon deactivation of the GATE_{FLUX} signal 1302, only a small amount of charge is released to the source capacitor C_{Res}, and the voltage V_{CRes-diff} 1306 is therefore kept below the forward voltage of the laser diode D_{L}. Since the voltage V_{CRes-diff} 1306 is lower than the forward voltage of the laser D_{L}, the GATE_{FLUX} signal 1302 can be activated after any amount of time in order to ramp up the current i_{LS} 1304 in the inductor Ls without causing current through the laser diode D_{L}. This behavior may be useful if there is a long amount of time between laser pulses because there is not a significant amount of charge across the source capacitor C_{Res} that could be lost due to leakage current in the circuit or components.

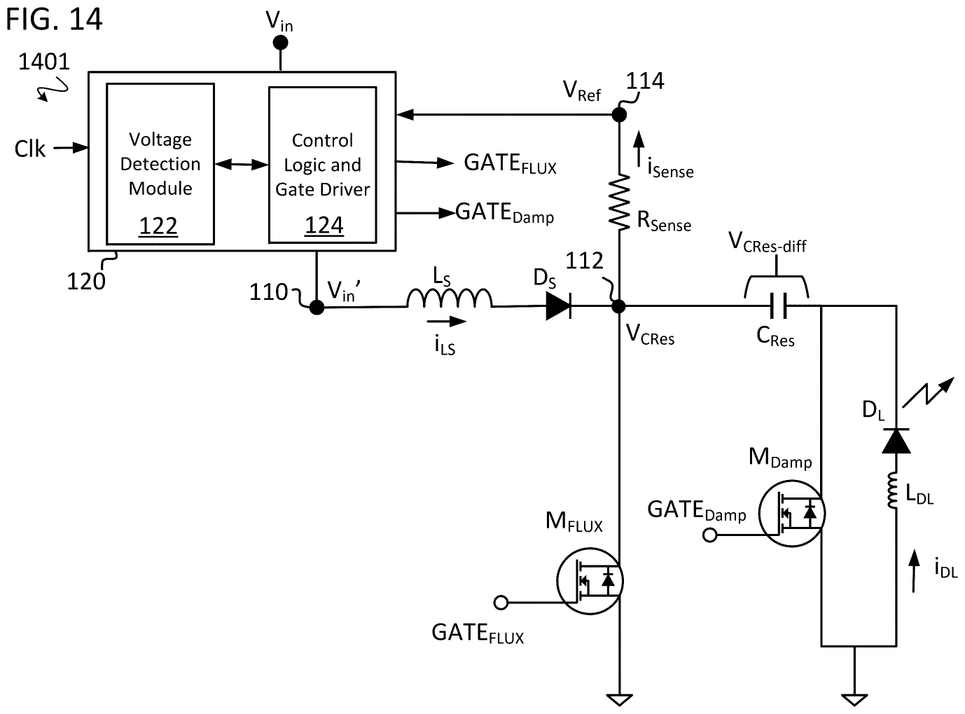

FIG. 14 shows another example of a laser diode driver 1401 that eliminates the need for undervoltage protection circuitry for a shorted pulse emission switch M_{DL}, in accordance with some examples. The laser diode driver 1401 includes all of the elements of the laser diode driver 1201 shown in FIG. 12; however, the damping resistor R_{Damp} and diode D_{F} of FIG. 12 are replaced by an actively controlled damping switch M_{Damp} that is controlled by a damping switch gate signal GATE_{Damp}. Any of the example implementations of the high-speed voltage detection module 122 disclosed herein are operable for use in the context of the driver 1401.

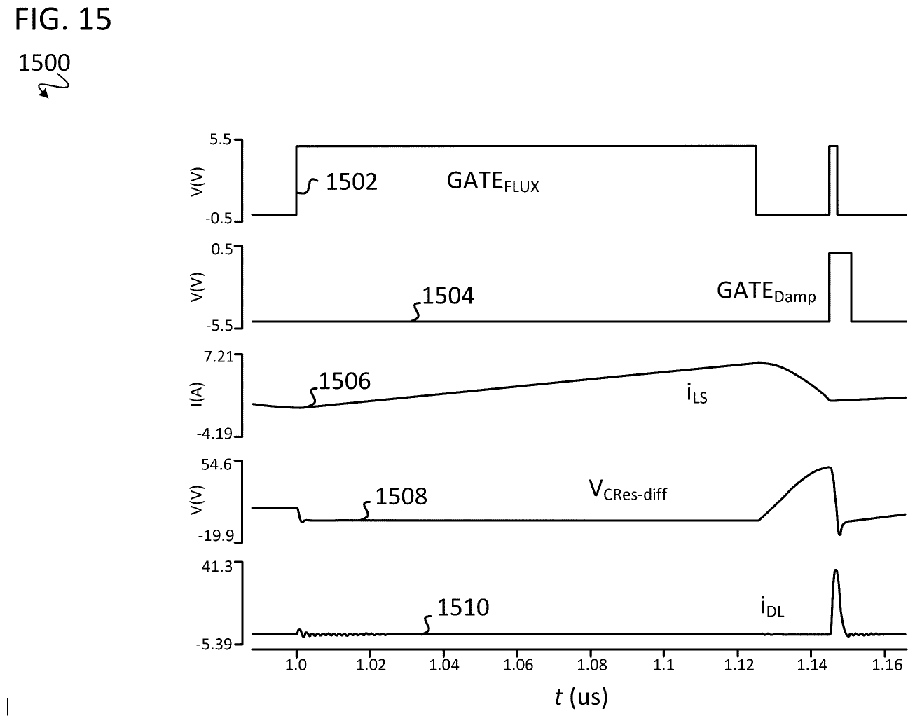

FIG. 15 shows example plots of signals 1500 related to the operation of the driver 1401 shown in FIG. 14, in accordance with some examples. The signals shown include the fluxing/firing switch gate driver signal GATE_{FLUX} 1502, the damping switch gate driver signal GATE_{Damp} 1504, the current through the inductor i_{LS} 1506, the voltage V_{CRes-diff} 1508, and the current through the laser diode i_{DL} 1510. In the example shown, the damping switch M_{Damp} is momentarily enabled after pulse emission of the laser diode D_{L} to advantageously mitigate resonant oscillations within the laser diode driver 1401.

Similar to the previously disclosed examples, an optional damping resistor (not shown) could be placed in series with the damping switch M_{Damp} in order to speed up the negative di/dt of the laser current and reduce subsequent laser current and voltage oscillations. Using this example, the damping switch M_{Damp} can be enabled during fluxing, during or immediately after laser diode firing, or at any other time in order to prevent current flow (and light) in the laser diode D_{L}. In other examples, an N-type switch, or two switches in series may be used in place of the damping switch M_{Damp}.

Because the current i_{LS} through the inductor Ls will ramp when pulse emission through the laser diode D_{L} occurs, the driver 1401 advantageously keeps the fluxing switch M_{FLUX} in an enabled state in order to develop enough current (“fluxing”) to fully charge the source capacitor C_{Res}. However, the configuration shown in FIG. 14 advantageously does not charge the source capacitor C_{Res} if there is a short across the fluxing switch M_{FLUX}.

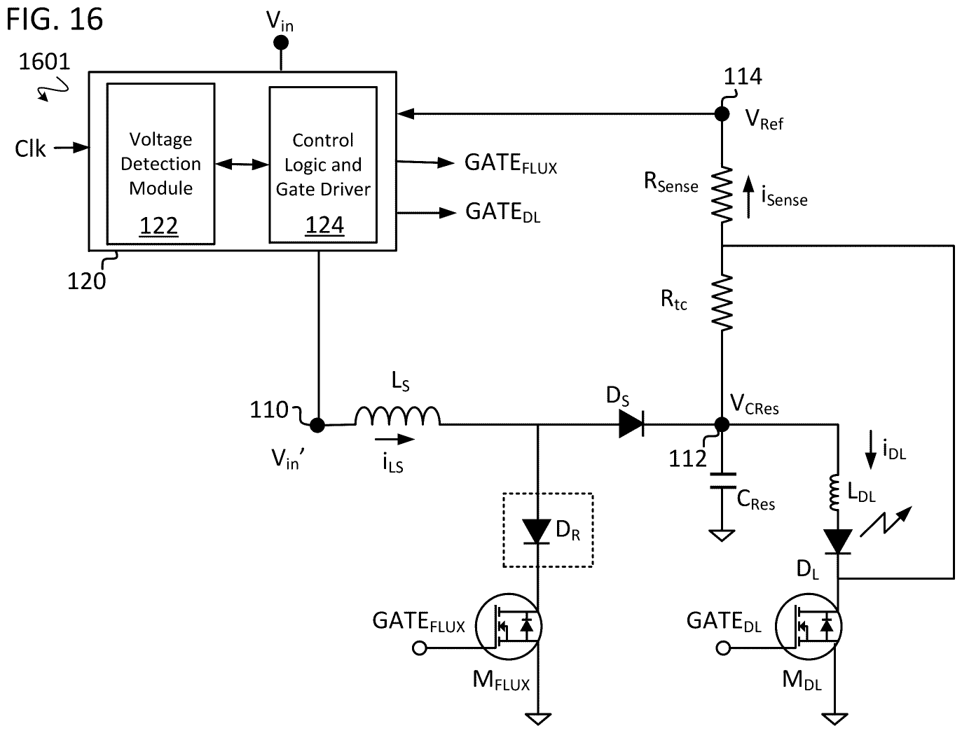

FIG. 16 shows an example of a laser diode driver 1601 that is similar to the laser diode driver 101, but is advantageously configured to sense a voltage developed at the cathode of the laser diode D_{L}, in accordance with some examples. Any of the example implementations of the high-speed voltage detection module 122 disclosed herein are operable for use in the context of the driver 1601.

The voltage sensing arrangement in FIG. 16 provides significant benefits for fault detection and system reliability. In particular, voltage sensing at a cathode terminal of the laser diode D_{L} enables more robust detection of a short circuit condition of the pulse emission switch M_{DL} as compared to examples that only sense an anode terminal voltage of the laser diode D_{L}. For example, in an example scenario, the anode voltage of the laser diode D_{L} may be sensed when the regulated input voltage Vᵢₙ′ is 5 V, and the laser voltage at a current level of 100 mA is also 5 V. Many laser diodes have a forward voltage that is greater than or equal to 4 V for an operating current of 100 mA. In this scenario, the anode voltage of the laser diode D_{L} would tend to remain near 5 V even if the pulse emission switch M_{DL} is shorted. However, under the same fault condition, the cathode voltage of the laser diode D_{L} would be driven very close to zero volts, thereby making a short condition readily detectable by the voltage detection module 122.

The example illustrated in FIG. 16 further includes an additional resistor R_{tc}, which is a low-value resistor (for example, 100Ω or 1 kΩ) coupled between the cathode of the laser diode D_{L} and the anode of the laser diode D_{L}. For many laser diodes, the resistor R_{tc} advantageously has little impact on the emitted laser light waveform. This is because, in order to achieve a 1 kW peak light power, an example laser diode may reach a peak current of 340 A with a forward voltage of 14 V, at which point the current through a 100 $2 R_{tc} resistor would be approximately 1/2400 of the laser current (14 V/100 Ω=140 mA). The resistor R_{tc} serves to rapidly pull the cathode voltage of the laser diode D_{L} toward the anode voltage following a voltage disturbance across the laser diode D_{L}, such as after pulse emission or when the source capacitor C_{Res} is quickly charged. Since the reverse leakage current and forward current of the laser diode will tend to keep the low frequency voltage across the laser diode to near zero Volts, some implementations may not include the Rie resistor (for example, if only voltages greater than 50 V are being sensed).

By selecting an appropriate value for the resistor R_{tc}, the RC time constant formed by R_{tc} and the combined parasitic capacitance across the laser diode D_{L} and the pulse emission switch M_{DL} can be made substantially lower than a delay or blanking time implemented in the voltage detection module 122. For example, if the delay (blanking) time is selected to be three times greater than the resulting RC time constant, the circuit will allow for three RC time constants to elapse, ensuring that the cathode voltage has recovered by at least 95% after the disturbance prior to the end of the blanking time.

In some examples, a delay or blanking circuit (not shown) may be included within the voltage detection module 122 for voltage sensing at the V_{Ref} node 114, thereby enabling a user to select an R_{tc} value that optimizes the response time and accuracy of the voltage detection module 122. This configuration enhances the ability of the voltage detection module 122 to discriminate between normal operating conditions and fault conditions of the laser diode driver 1601, such as a shorted pulse emission switch M_{DL}.

As disclosed herein, other example implementations of the voltage detection module 122 may advantageously use one or more resistor divider circuits, as described below, for fast and accurate voltage sensing at one or more nodes of the laser diode driver circuits disclosed herein or in other high-voltage sensing contexts. Resistor divider circuits are conventionally used to sense voltages at levels higher than those directly compatible with low-voltage integrated circuit (IC) inputs. In such arrangements, an external resistor is coupled between the high-voltage node and the IC, and an internal resistor is disposed within the IC to complete the divider network. The resulting lower reference voltage may then be provided to an amplifier or comparator circuit, which is operable to generate an output signal based on the sensed high-voltage level. However, when the resistor divider includes both an external resistor and an internal resistor, several sources of error may arise. For example, mismatches in temperature coefficient, voltage coefficient, and long-term stability between the external and internal resistors can degrade accuracy over time and operating conditions. In addition, parasitic resistance present in the signal path between the external resistor and the internal resistor may further introduce error.

Such parasitic resistance may result from physical structures added for electrostatic discharge (ESD) protection, transmission gate or CMOS switch circuitry used to enable test modes, or optional internal resistor configurations. While acceptable matching between the external and internal resistors can be achieved by careful selection of resistor materials, trimming of the internal resistor value, and minimizing parasitic resistance to be substantially less than either the external or internal resistor value, these approaches require additional circuitry, increased circuit board area, and extended test time. Moreover, such techniques may limit the flexibility of the resistor divider network and complicate integration in high-speed or precision sensing applications.

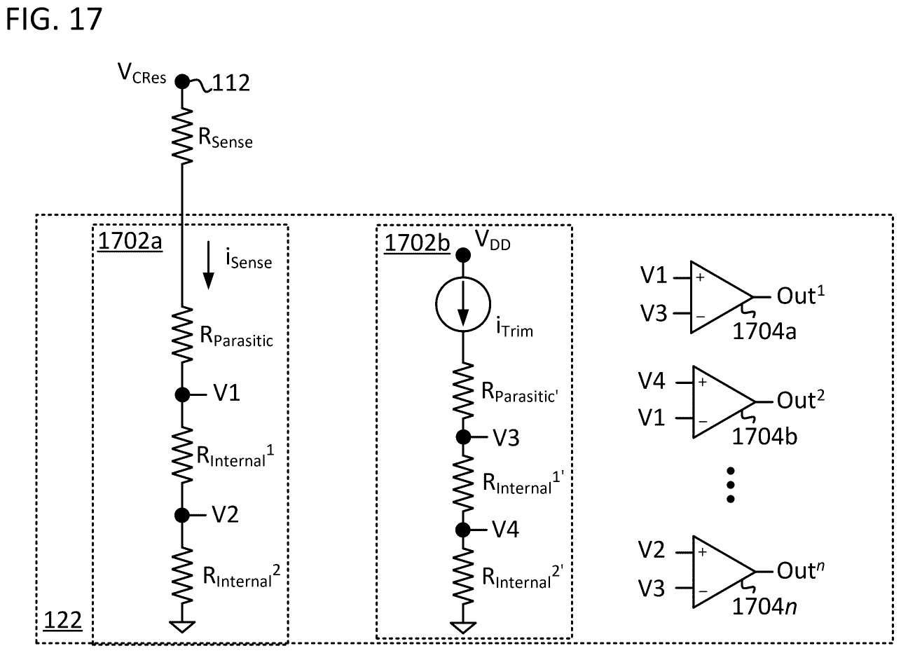

FIG. 17 is a sixth example implementation of the high-speed voltage detection module 122 introduced in FIG. 1, in accordance with some examples. In the example shown, the high-speed voltage detection module 122 employs matched internal resistor strings and one or more comparator paths to sense an external high-voltage node of a high-voltage domain with low-voltage circuitry of a low-voltage domain. The module 122 is configured to sense the voltage V_{CRes} developed at node 112 of an external circuit (e.g., the source capacitor C_{Res} terminal in the pulsed light emitting diode drivers described herein) through a high impedance (e.g., 10 MΩ-30 MΩ) external sense resistor R_{Sense} that generates a corresponding sense current i_{Sense}. However, it is understood that the high-speed voltage detection module 122 is operable to sense a voltage developed at any other node of the pulsed light-emitting diode drivers that are disclosed herein.

The high-speed voltage detection module 122 shown in FIG. 17 includes a sense resistor string 1702a, a reference resistor string 1702b of a reference network, and one or more voltage comparator circuits 1704a-n of a comparison network. The sense resistor string 1702a is configured to be electrically connected to a terminal of the external sense resistor R_{Sense} to receive the sense current i_{Sense} and includes one or more internal resistors of a resistor divider network to develop one or more voltages across the resistors therein based on the received sense current i_{Sense}. In the example shown, two internal resistors, R_{Internal}¹ and R_{Internal}², are used, but it is understood that the number of internal resistors in each of the resistor strings 1702a-b may be selected to be fewer than two or more than two. Also shown is a representation of a parasitic resistance R Parasitic along the signal path between R_{Sense} and the internal resistors R_{Internal}¹ and R_{Internal}². The parasitic resistance R_{Parasitic} may be representative of electrostatic discharge (ESD) protection resistance, transmission gate switch resistance, and/or routing resistance. The sense resistor string 1702a includes one or more voltage tap nodes, and, in the example shown, includes voltage tap nodes V1 and V2.

The reference resistor string 1702b includes a configurable current source i_{Trim}, and one or more internal resistors of a respective resistor divider network. In the example shown, the reference resistor string 1702b includes two internal resistors R_{Internal}^{1′} and R_{Internal}^{2′}. Each of the internal resistors of the reference resistor string 1702b is substantially matched in processing variation and temperature coefficient to a corresponding internal resistor of the sense resistor string 1702a (e.g., R_{Internal}¹ is matched to R_{Internal}^{1′}). Also shown is a representation of a parasitic resistance R_{Parasitic}′ along the signal path between the current source i_{Trim} and the internal resistors R_{Internal}^{1′} and R_{Internal}^{2′}, and which may include, for example, electrostatic discharge (ESD) protection resistance, transmission gate switch resistance, and/or routing resistance. The reference resistor string 1702b includes one or more voltage tap nodes, and, in the example shown, includes voltage tap nodes V3 and V4.

As used herein, “substantially matched in processing variation and temperature coefficient” means the resistors may be implemented from the same resistive material, unit geometry, and/or layout environment on the same die such that they experience substantially the same process-induced value shifts and the same temperature-dependent drift. Thus, while absolute resistance may vary with process and temperature, the ratios between corresponding resistor elements remain essentially constant over the operating range (e.g., an absolute resistance mismatch on the order of ≤˜1%—and in some examples ≤0.1%—with temperature-coefficient tracking such that any differential drift is negligible relative to the selected comparator threshold step or hysteresis).

In some examples, the internal resistor pairs (R_{Internal}¹, R_{Internal}^{1′}) and (R_{Internal}², R_{Internal}^{2′}) may be made from equal matched segment sizes of the same resistor type within the module 122 such that the resistors of each pair are very accurately matched in both processing variation and temperature coefficient (e.g., having a variation of less than 0.1%). Because each corresponding internal resistor pair of the resistor strings 1702a-b is matched as such, each pair is subject to the same variation in respective absolute value due to other influences (e.g., voltage and temperature).

Additionally, the internal resistors of the resistor strings 1702a-b may be implemented as relatively narrow resistors to reduce the amount of area within the module 122 that the resistors consume, thereby conserving valuable circuit board space. That is, the internal resistors may be implemented as narrow (small area) resistors since the resistor pairs will be matched in value and temperature coefficient, even though they may have a larger absolute variation over process due to the process delta width being a larger proportion of a narrow resistor's width. However, because each internal resistor pair is matched, absolute variations of the resistors do not affect the resultant ratio of values developed within the resistor strings 1702a-b.

Additionally, in the example shown, each of the resistor strings 1702a-b are tied to the same return path at a bias voltage, such as ground, a low voltage, or a switch to ground. Since both of the resistor strings 1702a-b are tied to the same, or nearly the same return path during operation, the value of the parasitic resistances R_{Parasitic}, R_{Parasitic}′ have little to no effect on the matching of the resistor strings 1702a-b.

In applications in which the resistance value of the external sense resistor R_{Sense} is substantially greater than the combined resistance of the internal resistors and any parasitic resistance (for example, by a factor of 100 or more), the high-speed voltage detection module 122 illustrated in FIG. 17 is advantageously operable to mitigate the need for precise matching between the external and internal resistors, and to relax the requirement that the parasitic resistance be minimized to the greatest extent possible.

In the example shown, the configurable current source i_{Trim} is generated based on the internal voltage V_{DD} and is operable to source a configurable current level into the reference resistor string 1702b in order to establish precise reference potentials at the voltage taps V3 and V4 while maintaining a low static power draw. The trimmed current source i_{Trim} is configured to source an accurate, programmable current into the reference resistor string 1702b, thereby establishing reference voltages at the one or more tap nodes (e.g., V3, V4). The voltage developed at each tap node of the reference resistor string 1702b may then be compared, via the one or more comparator circuits 1704a-n, to a voltage developed at a corresponding tap node of the sense resistor string 1702a, which is electrically connected to the external sense resistor R_{Sense}.

For example, three comparators 1704a, 1704b, and 1704n may be advantageously used to set multiple trip points to track a rising and falling voltage level of V_{CRes} using a single sense resistor string 1702a. The selection and polarity of the comparator inputs can be configured to detect rising and/or falling threshold crossings as desired. In the example shown, a first comparator 1704a may compare V1 and V3 to generate a comparison output signal Out¹, a second comparator 1704b may compare V4 and V1 to generate a comparison output signal Out², and an n^{th} comparator 1704″ may compare V2 and V3 to generate a comparison output signal Outⁿ. In some examples, one or more of the comparator outputs (Out¹, Out², Outⁿ) are provided to control logic (e.g., within module 122 or a separate controller) that is operable to regulate a source capacitor charge level, to enable or inhibit pulse emission switching, to perform fault detection (e.g., overvoltage/undervoltage), and/or to initiate protective actions. In some examples, not shown, the comparison output signals may be received and processed by an output logic circuit that is the same or similar to the output logic circuit 330 to generate an aggregated output voltage comparison signal, as introduced with reference to FIG. 3.

Though FIG. 17 shows the use of V_{DD} to bias the resistor string 1702b, other biasing schemes may be used in alternative examples, including biasing from a regulated internal rail or from a precision on-chip current source, provided that the resulting tap potentials remain within the allowable low voltage operating range of the comparator circuitry.

Because the trimmed current source i_{Trim} is generated by a single circuit on the integrated circuit and may be mirrored or replicated to multiple locations within the voltage detection module 122 as needed, the circuitry, silicon area, and test time required to implement the reference network are significantly reduced compared to approaches that require precise resistor matching for each sensing instance. Furthermore, since the resistance value of R_{Sense} is much greater than the resistance of R_{Parasitic} and the internal resistors of the sense resistor string 1702a, the voltage drop across R Sense is correspondingly much larger than the voltage drop across R_{Parasitic} plus the internal resistors. As a result, a given percentage variation in the voltage across R_{Parasitic}, R_{Parasitic}′, and the internal resistors of the resistor strings 1702a-b, will produce only a proportionally smaller percentage variation in the voltage across R_{Sense}. For example, if the voltage V_{CRes} at node 112 is 50.5 V and the voltage drop across R_{Parasitic} plus the internal resistors R_{Internal}¹ and R_{Internal}² is 0.5 V±50% (i.e., 0.25 V to 0.75 V due to resistance variation), the resulting variation in the voltage across R_{Sense} will be 50 V±0.5% (i.e., 49.75 V to 50.25 V).

In operation, the large resistance value of R_{Sense} limits leakage current from the external high voltage node 112 into the low voltage sensing network, while still allowing the resistor string 1702a to develop low voltage tap potentials (V1, V2) that are representative of the sensed voltage V_{CRes}. Moreover, since the resistor strings 1702a-b are implemented with substantially identical resistor segment geometries and share a common return node, the comparison of a voltage tap of the sense resistor string 1702a to a corresponding tap of the reference resistor string 1702b provides a precise and repeatable thresholding mechanism.

The optional trimmed current i_{Trim} sourced into the reference resistor string 1702b may be selected among multiple current levels to adjust the absolute reference potentials at V3, V4 and thereby program one or more comparator trip points without changing external components. In various examples, additional voltage tap nodes, additional comparators, and/or multiplexing may be provided to realize a larger set of selectable thresholds and hysteresis behaviors. That is, although FIG. 17 depicts two tap nodes per resistor string for clarity, any suitable number of tap points and segment counts may be implemented.

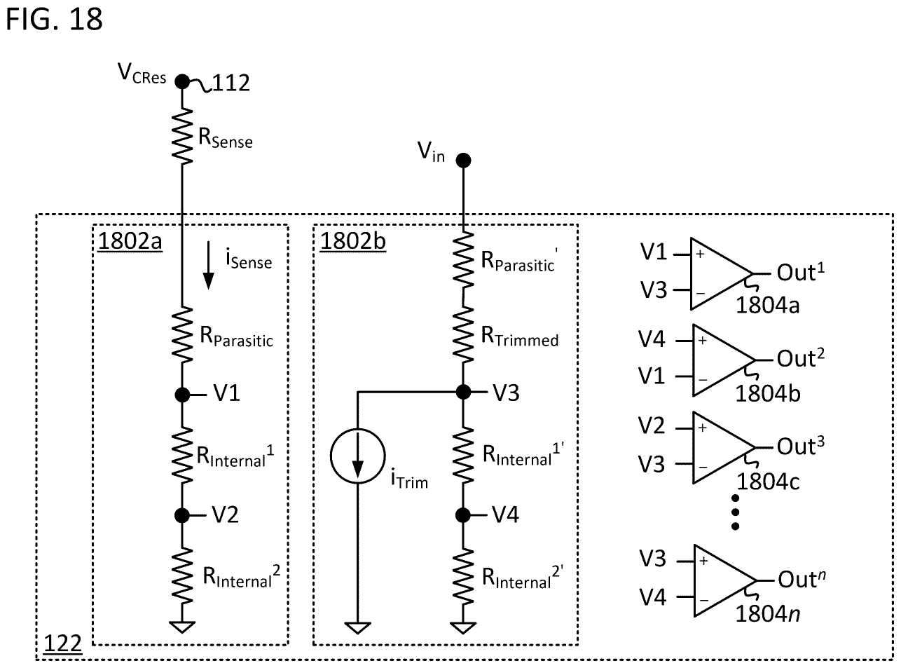

FIG. 18 is a seventh example implementation of a high-speed voltage detection module 122, in accordance with some examples. The architecture shown in FIG. 18 is similar to that of FIG. 17. In the example shown, the high-speed voltage detection module 122 employs matched internal resistor strings 1802a-b and one or more comparator paths 1804a-n to sense an external high voltage node with low voltage circuitry, while providing enhanced flexibility in setting comparator trip points relative to a reference voltage Vᵢₙ.

As in FIG. 17, the high-speed voltage detection module 122 is configured to sense the voltage V_{CRes} developed at node 112 of an external circuit (e.g., the source capacitor node in the pulsed light emitting diode driver described herein) through a high impedance external sense resistor R_{Sense} that generates a corresponding sense current i_{Sense}. The sense resistor string 1802a is electrically connected to a terminal of R_{Sense} and includes one or more internal resistors (e.g., R_{Internal}¹, R_{Internal}²), as well as a representation of parasitic resistance R_{Parasitic} along the signal path. The sense resistor string 1802a includes one or more voltage tap nodes, such as V1 and V2.

The reference resistor string 1802b is of a reference network and is configured to receive the input voltage Vᵢₙ and includes a parasitic resistance R_{Parasitic}′, a trimmed resistor R_{Trimmed}, one or more internal resistors (e.g., R_{Internal}^{1′}, R_{Internal}^{2′}), and a configurable current source I_{Trimmed}. The trimmed resistor R_{Trimmed} is selected and adjusted to be as accurate as possible over all variations, including temperature, voltage, and lifetime, thereby providing a stable reference for comparison. The reference resistor string 1802b also includes one or more voltage tap nodes, such as V3 and V4.

In examples in which the resistor divider ratio of the sense resistor string 1802a (between R_{Sense} and the sum of R_{Parasitic} and the internal resistors R_{Internal}¹ and R_{Internal}²) is set to be the same as the resistor divider ratio of the reference resistor string 1802b (between R_{Trimmed} and the sum of the internal resistors R_{Internal}^{1′} and R_{Internal}^{2′}), a comparator circuit of the comparator circuits 1804a-n may be configured to change state when the external voltage V_{CRes} is equal to the reference voltage Vᵢₙ, provided that the current source I_{Trimmed} is set to zero. By increasing the current level of I_{Trimmed}, the comparator trip point may be adjusted such that the comparator changes state when V_{CRes} is equal to Vᵢₙ minus a programmable offset determined by the product of I_{Trimmed} and R_{Trimmed}. As such, the comparator trip point may be selected between Vᵢₙ and Vᵢₙ minus multiple selectable voltage levels, depending on the configuration of I_{Trimmed} and R_{Trimmed}. By selecting different resistor divider tap points (V1 through V4), a comparator circuit of the comparator circuits 1804a-n may be configured to change state when the external voltage V_{CRes} is equal to a ratio of the reference voltage Vᵢₙ, for example Vᵢₙ times 2 or Vᵢₙ times 0.5, or further by increasing the current level of I_{Trimmed}, the comparator trip point may be selected between Vᵢₙ times a ratio and (Vᵢₙ times a ratio) minus multiple selectable voltage levels, depending on the configuration of I_{Trimmed} and R_{Trimmed}.

In some examples, the trimmed resistor R_{Trimmed} may be implemented by increasing or decreasing the number of resistor segments of R_{Trimmed}, and a different untrimmed current may be generated based on the same resistor type across an internal reference voltage and placed across an untrimmed portion of R_{Trimmed}. This configuration removes the need for a trimmed current source and may further increase the voltage level at the top of the I_{Trimmed} current sink, providing additional flexibility in setting comparator thresholds.

As in FIG. 17, the internal resistors of the sense and reference resistor strings 1802a-b may be constructed from substantially identical resistor segment geometries and materials, ensuring high precision matching between corresponding tap nodes. Both resistor strings may be tied to a common return path, such as ground, or to any suitable low-voltage node, with minimal impact on matching performance. The selection and polarity of the comparator inputs may be configured to detect rising and/or falling threshold crossings as desired. For example, comparator circuits 1804a, 1804b, and 1804n of a comparison network may be used to compare various combinations of tap nodes (e.g., V1 and V3, V4 and V1, V2 and V3) to generate respective comparison output signals (Out¹, Out², Out³, Outⁿ). In some examples, not shown, the comparison output signals may be received and processed by an output logic circuit that is the same or similar to the output logic circuit 330 to generate an aggregated output voltage comparison signal, as introduced with reference to FIG. 3.

Though FIG. 18 shows the use of Vᵢₙ to bias the resistor string 1802b, other biasing schemes may be used in alternative examples, including biasing from a regulated internal rail or from a precision on-chip current source, provided that the resulting tap potentials remain within the allowable low voltage operating range of the comparator circuitry.

In operation, the architecture illustrated in FIG. 18 enables precise and programmable threshold detection of the external voltage V_{CRes} relative to the reference voltage Vᵢₙ, with the ability to introduce selectable offsets via the trimmed resistor and current source. This approach provides enhanced flexibility for applications requiring dynamic adjustment of comparator trip points, such as fault detection, pulse emission control, or adaptive regulation of source capacitor charge levels. As with the example described above with reference to FIG. 17, additional voltage tap nodes, comparator circuits, and multiplexing may be provided to realize a larger set of selectable thresholds and hysteresis behaviors. Thus, although FIG. 18 depicts two tap nodes per resistor string for clarity, any suitable number of tap points and segment counts may be implemented.

Reference has been made in detail to examples of the disclosed invention, one or more examples of which have been illustrated in the accompanying figures. Each example has been provided by way of explanation of the present technology, not as a limitation of the present technology. In fact, while the specification has been described in detail with respect to specific examples of the invention, it will be appreciated that those skilled in the art, upon attaining an understanding of the foregoing, may readily conceive of alterations to, variations of, and equivalents to these examples. For instance, features illustrated or described as part of one example may be used with another example to yield a still further example. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. An apparatus comprising:
a voltage detection module; and
a sense resistor configured to couple a low-voltage domain of the voltage detection module to a high-voltage node of an external circuit and to develop a sense current based on a voltage developed at the high-voltage node, the sense current being received at a sensing node of the voltage detection module;
wherein the voltage detection module comprises:
a reference network configured to establish one or more threshold conditions at respective internal nodes within the voltage detection module, the one or more threshold conditions being generated based on one or more biasing circuits; and
a comparison network configured to generate one or more comparison output signals based on a received current level of the sense current and the one or more threshold conditions.

2. The apparatus of claim 1, wherein:
the sense resistor has a resistance of at least 1 MΩ.

3. The apparatus of claim 1, wherein:
the reference network comprises one or more current sources that establish respective current thresholds; and
the comparison network is configured to generate the one or more comparison output signals based on respective comparisons of the current thresholds to a comparison current derived from the sense current.

4. The apparatus of claim 3, wherein:
the comparison network comprises one or more inverter stages, each having a current-summing input node; and
the reference network is configured to inject a respective fixed threshold current into each current-summing input node, such that each inverter stage generates a comparison output signal based on a sum of the fixed threshold current and a current based on the sense current.

5. The apparatus of claim 3, further comprising:
a level-shift circuit between the sensing node and the comparison network to control a voltage level of a regulated voltage at the sensing node.

6. The apparatus of claim 3, wherein:
the comparison current is generated by a current-generation circuit that receives the sense current through the sense resistor and regulates a voltage at a sensing node of the low-voltage domain.

7. The apparatus of claim 3, further comprising:
an electrostatic discharge protection network having a clamp-reference node that is actively biased to a regulated voltage at the sensing node of the voltage detection module.

8. The apparatus of claim 6, wherein:
the regulated voltage at the sensing node is a positive voltage referenced to the low-voltage domain; and
the comparison current is substantially equal to the current through the sense resistor.

9. The apparatus of claim 6, wherein:
the comparison network further comprises a timing control circuit configured to blank the one or more comparison output signals during defined time intervals.

10. The apparatus of claim 3, wherein:
the one or more current sources comprise a threshold-current generation circuit that is operable to provide a configurable current threshold level.

11. The apparatus of claim 3, wherein:
the comparison network comprises one or more current level comparators, respectively configured to generate respective comparison output signals based on a defined relation between the comparison current and a corresponding one of the current thresholds.

12. The apparatus of claim 3, wherein:
the comparison current is generated by a voltage-to-current converter circuit that forces a sensing node of the low-voltage domain to a regulated voltage while receiving the sense current through the sense resistor.

13. The apparatus of claim 12, wherein:
the voltage-to-current converter circuit comprises a transconductance amplifier configured to maintain the sensing node at a regulated voltage and to generate the comparison current proportional to a difference between the voltage at the high-voltage node and the regulated voltage.

14. The apparatus of claim 1, wherein:
the reference network comprises a reference resistor string having one or more tap nodes and a biasing circuit configured to generate one or more reference tap voltage potentials;
the comparison network comprises one or more voltage comparator circuits having inputs respectively coupled to a sense tap node of a sense resistor string that is coupled to the sense resistor and to a reference tap node of the reference resistor string; and
each of the voltage comparator circuits is configured to generate a respective comparison output signal of the one or more comparison output signals based on a comparison of a voltage level at the sense tap node to a voltage level at the reference tap node.

15. The apparatus of claim 14, wherein:
the sense resistor has a resistance of at least 1 MΩ.

16. The apparatus of claim 14, wherein:
the sense resistor string and the reference resistor string comprise substantially matched resistor segments in processing variation and temperature coefficient and are tied to a common return node.

17. The apparatus of claim 14, wherein:
the biasing circuit comprises a current source circuit configured to provide a current into the reference resistor string from an internal supply voltage to establish the reference tap voltage potentials.

18. The apparatus of claim 14, wherein:
the biasing circuit generates the reference tap voltage potentials from an input voltage using one or both of a trimmed resistor and a configurable current source such that a comparator trip point is selectable.

19. The apparatus of claim 14, wherein:
the comparison network comprises a plurality of voltage comparator circuits, each being respectively coupled to respective tap nodes of the sense resistor string and the reference resistor string to provide a plurality of voltage comparison output signals.

20. The apparatus of claim 1, wherein:
a first terminal of the sense resistor is directly electrically connected to the sensing node of the voltage detection module, and a second terminal of the sense resistor is directly electrically connected to a cathode terminal of a laser diode; and
a first terminal of an additional resistor is directly electrically connected to the second terminal of the sense resistor and to the cathode terminal of the laser diode, and a second terminal of the additional resistor is directly electrically connected to an anode terminal of the laser diode.
